(19) United States
(12) Patent Application Publication
(10) Pub. No.: US 2022/0395821 A1
(43) Pub. Date: Dec. 15, 2022

(54) COVALENT ORGANIC FRAMEWORKS AND APPLICATIONS AS PHOTOCATALYSTS

(71) Applicant: University of South Florida, Tampa, FL (US)

(72) Inventors: Shengqian MA, Tampa, FL (US); Qi SUN, Tampa, FL (US)

(21) Appl. No.: 17/776,762

(22) PCT Filed: Nov. 13, 2020
(86) PCT No.: PCT/US2020/060556

§ 371 Date: May 13, 2022

Related U.S. Application Data
(60) Provisional application No. 62/935,726, filed on Nov. 15, 2019.

(51) Int. Cl. B01J 35/00; B01J 31/06; B01J 35/02; B01J 37/02

(52) U.S. Cl. CPC B01J 35/004; B01J 31/063; B01J 35/026; B01J 37/0219; B01J 2231/44

(57) ABSTRACT

Described herein are covalent organic frameworks. The covalent organic frameworks have unique structural and physical properties, which lends them to be versatile in a number of different applications and uses. In one aspect, the covalent organic frameworks are composed of a plurality of fused aromatic groups and electron-deficient chromophores. The covalent organic frameworks are useful as photocatalysts in a number of different applications.

### CROSS REFERENCE TO RELATED APPLICATIONS

This application claims priority upon U.S. provisional application Ser. No. 62/935,726 filed on Nov. 15, 2019. This application is hereby incorporated by reference in its entirety.

### BACKGROUND

Harnessing the energy of light to make and break chemical bonds usually involves semiconducting photocatalysts, with titanium dioxide being the benchmark.¹⁻⁴ Recently, organic photoredox catalysts have been acknowledged in a myriad of chemical transformations due to their diverse synthetic modularity, promising for the discovery and optimization of new reaction routes.⁵⁻⁷ While impressive advances have been achieved, engineering the optical properties to improve efficiency through the direct functionalization of chromophore moieties is often cumbersome and synthetically challenging. In addition, the molecular photoredox catalysts often suffer from photobleaching, compromising their long-term stable outputs.⁸ Alleviating the deactivation and enhancing control over the conversion of light into chemical energy are essential in furthering this technology.⁹⁻¹⁹

### SUMMARY

Described herein are covalent organic frameworks. The covalent organic frameworks have unique structural and physical properties, which lends them to be versatile in a number of different applications and uses. In one aspect, the covalent organic frameworks are composed of a plurality of fused aromatic groups and electron-deficient chromophores. The covalent organic frameworks are useful as photocatalysts in a number of different applications.

The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below:

FIGS. 1A-1B represent several organic frameworks.

FIGS. 2A-2C represent the characterization of Py-Td: (a) experimental and calculated PXRD patterns, inset: SEM image of Py-Td (scale bar is 1 um). (b) graphic view of AA-stacking mode of Py-Td (gray, C; blue, N; yellow, S, white, H). (c) N₂ sorption isotherms collected at 77 K, inset: corresponding pore size distribution of Py-Td derived from the NLDFT method.

FIGS. 3A-3C represents optical property investigation: (a) Normalized UV-vis absorption spectra, inset: digital images of Py-Td, Etta-Td, Py-Py, and Etta-Py COFs, from top to bottom. (b) Tauc plots. (c) Mott-Schottky plots in 0.2 M Na₂SO₄ aqueous solution at 1000 Hz.

FIGS. 4A-4B provide and structure profiles of (a) Py-Td and (b) Etta-Td.

FIGS. 5A-5C provide excited state lifetime and reactive oxygen species investigation. (a) Time-correlated single photon counting profiles of Py-Td and Etta-Td. (b) EPR spectra of CH₃CN solutions of DMPO (violet) and TEMP (cyan) in the presence of Py-Td after irradiation under visible light.

FIG. 6 provides a schematic illustration of the column photoreactor with organic framework in a continuous flow system.

FIG. 7 provides a schematic illustration of the preparation of Py-Td coated fabric for photooxidation of CEES.2

FIG. 8 provides the IR spectra of Py-Td COF.

FIG. 9 shows the solid-state ¹³C NMR spectrum of the Py-Td COF.

FIG. 10 shows the PXRD profiles of Py-Td (top: experimental, bottom: Pawley refinement, black: their difference) (R_{WP} value is 2.1).

FIG. 11 shows the SEM image of Py-Td.

FIG. 12 shows the PXRD patterns of pristine Py-Td and after treatment for 24 h under various conditions.

FIG. 13 shows the IR spectra of Py-Py COF.

FIG. 14 shows Solid-state ¹³C NMR spectrum of the Py-Py COF.

FIG. 15 shows PXRD profiles of Py-Py (top: experimental, bottom: Pawley refinement, black: their difference) (R_{WP} value is 5.6).

FIG. 16 shows calculated and experimental PXRD patterns (top) and graphic view of AA-stacking mode of Py-Py (gray, C; blue, N; white, H) (bottom).

FIG. 17 shows N₂ sorption isotherms collected at 77 K of Py-Py (top) and corresponding pore size distribution based on the NLDFT method. The BET surface area of Py-Py was calculated to be 958 m² g⁻¹.

FIG. 18 shows SEM images of Py-Py.

FIG. 19 shows the IR spectra of Etta-Td COF.

FIG. 20 shows the solid-state ¹³C NMR spectrum of the Etta-Td COF.

FIG. 21 shows PXRD profiles of Etta-Td (top: experimental, bottom: Pawley refinement, black: their difference) (R_{WP} value is 7.0).

FIG. 22 shows calculated and experimental PXRD patterns (top) and Graphic view of AA-stacking mode of Etta-Td (gray, C; blue, N; yellow, S, white, H) (bottom).

FIG. 23 shows N₂ sorption isotherms collected at 77 K of Etta-Td (top) and corresponding pore size distribution based on the NLDFT method. The BET surface area of Etta-Td was calculated to be 749 m² g⁻¹.

FIG. 24 shows SEM images of Etta-Td.

FIG. 25 shows the IR spectra of Etta-Py COF.

FIG. 26 shows the solid-state ¹³C NMR spectrum of the Etta-Py COF.

FIG. 27 shows SEM images of Etta-Py.

FIG. 28 shows PXRD profiles of Etta-Py (top: experimental, bottom: Pawley refinement, black: their difference) (R_{WP} value is 5.8).

FIG. 29 shows calculated and experimental PXRD patterns (top). Graphic view of AA-stacking mode of Etta-Py (gray, C; blue, N; white, H) (bottom).

FIG. 30 shows N₂ sorption isotherms collected at 77 K of Etta-Py (top) and corresponding pore size distribution based on the NLDFT method. The BET surface area of Etta-Py was calculated to be 1858 m² g⁻¹.

FIG. 31 shows cyclic voltammetry graph of ferrocene. The energy levels of LUMO of the COFs vs. vacuum were derived from the following equations, E_{LUMO}=−[E_{red}(onset)−E_{1/2}(Ferrocene)+4.8].

FIG. 32 shows cyclic voltammetry graph of the COF materials. Cyclic voltammetry of Py-Td, Etta-Td, Py-Py, and Etta-Py. According to the equation in Supplementary FIG. 15, the energy levels of LUMO of COFs vs. vacuum were calculated to be −3.59 eV, −3.57 eV, −3.61 eV, −3.62 eV, respectively.

FIG. 33 shows DFT calculation. Natural Transition Orbital (NTO) particle-hole representation of the repeat units of COF materials (Py-Td, Etta-Td, Py-Py, and Etta-Py from top to bottom, respectively), computed with B3LYP/6-31 G(d) basis set implemented in Gaussian 09 program package.

FIG. 34 shows N₂ sorption isotherms collected at 77 K (top) and PXRD pattern (bottom) of Py-Td-POP. The BET surface area of Py-Td-POP was calculated to be 477 m² g⁻¹.

FIG. 35 shows the EPR spectra of Py-Td in the solid state.

FIG. 36 shows recycling tests of Py-Td in the photocatalytic oxidation of thioanisole. Reaction conditions: thioanisole (5 μL), CHCN (1.0 mL), Py-Td (5 mg), O₂ and under irradiation of a Xe lamp.

FIG. 37 shows XRD pattern of the Py-Td COF after recycling five times (top) and the solid-state ¹³C NMR spectra of the fresh synthesized Py-Td and the one which has been recycled for five times (bottom).

FIG. 38 shows SEM images of nylon-66 fabric (top) and Py-Td coated nylon-66 fabric (bottom).

FIG. 39 shows PXRD patterns of the nylon-66 fabric (top) and the composite of Py-Td coated nylon-66 fabric (bottom).

### DETAILED DESCRIPTION

Before the present materials, articles and/or methods are disclosed and described, it is to be understood that the aspects described below are not limited to specific compounds, synthetic methods, or uses, as such may, of course, vary. It is also to be understood that the terminology used herein is for the purpose of describing particular aspects only and is not intended to be limiting.

In the specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “a solvent” includes mixtures of two or more solvents and the like.

“Optional” or “optionally” means that the subsequently described event or circumstance can or cannot occur, and that the description includes instances where the event or circumstance occurs and instances where it does not. For example, the compositions described herein may optionally contain a hydrophilic compound, where the hydrophilic compound may or may not be present.

Throughout this specification, unless the context dictates otherwise, the word “comprise,” or variations such as “comprises” or “comprising,” will be understood to imply the inclusion of a stated element, integer, step, or group of elements, integers, or steps, but not the exclusion of any other element, integer, step, or group of elements, integers, or steps.

As used herein, the term “about” is used to provide flexibility to a numerical range endpoint by providing that a given numerical value may be “a little above” or “a little below” the endpoint without affecting the desired result. For purposes of the present disclosure, “about” refers to a range extending from 10% below the numerical value to 10% above the numerical value. For example, if the numerical value is 10, “about 10” means between 9 and 11 inclusive of the endpoints 9 and 11.

As used herein, the term “admixing” is defined as mixing two or more components together so that there is no chemical reaction or physical interaction. The term “admixing” also includes the chemical reaction or physical interaction between the two or more components.

As used herein, “aryl group” is any carbon-based aromatic group including, but not limited to, benzene, naphthalene, etc. The term “aryl group” also includes “heteroaryl group,” which is defined as an aryl group that has at least one heteroatom incorporated within the ring of the aromatic ring. Examples of heteroatoms include, but are not limited to, nitrogen, oxygen, sulfur, and phosphorus. In one aspect, the heteroaryl group is imidazole. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

As used herein, a plurality of items, structural elements, compositional elements, and/or materials may be presented in a common list for convenience. However, these lists should be construed as though each member of the list is individually identified as a separate and unique member. Thus, no individual member of any such list should be construed as a de facto equivalent of any other member of the same list based solely on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an example, a numerical range of “about 1” to “about 5” should be interpreted to include not only the explicitly recited values of about 1 to about 5, but also to include individual values and sub-ranges within the indicated range. Thus, included in this numerical range are individual values such as 2, 3, and 4, the sub-ranges such as from 1-3, from 2-4, from 3-5, from about 1-about 3, from 1 to about 3, from about 1 to 3, etc., as well as 1, 2, 3, 4, and 5, individually. The same principle applies to ranges reciting only one numerical value as a minimum or maximum. The ranges should be interpreted as including endpoints (e.g., when a range of “from about 1 to 3” is recited, the range includes both of the endpoints 1 and 3 as well as the values in between). Furthermore, such an interpretation should apply regardless of the breadth or range of the characters being described.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed, that while specific reference to each various individual combination and permutation of these compounds may not be explicitly disclosed, each is specifically contemplated and described herein. For example, if a fused aromatic group is disclosed and discussed, and a number of different electron-deficient chromophores are discussed, each and every combination of fused aromatic group and electron-deficient chromophore that is possible is specifically contemplated unless specifically indicated to the contrary. For example, if a class of fused aromatic groups A, B, and C are disclosed, as well as a class of electron-deficient chromophores D, E, and F, and an example combination of A+D is disclosed, then even if each is not individually recited, each is individually and collectively contemplated. Thus, in this example, each of the combinations A+E, A+F, B+D, B+E, B+F, C+D, C+E, and C+F is specifically contemplated and should be considered from disclosure of A, B, and C; D, E, and F; and the example combination A+D. Likewise, any subset or combination of these is also specifically contemplated and disclosed. Thus, for example, the sub-group of A+E, B+F, and C+E is specifically contemplated and should be considered from disclosure of A, B, and C; D, E, and F; and the example combination of A+D. This concept applies to all aspects of the disclosure including, but not limited to, steps in methods of making and using the disclosed compositions. Thus, if there are a variety of additional steps that can be performed with any specific embodiment or combination of embodiments of the disclosed methods, each such composition is specifically contemplated and should be considered disclosed.

### Covalent Organic Frameworks (COF)

Described herein are covalent organic frameworks. The covalent organic frameworks have unique structural and physical properties, which lends them to be versatile in a number of different applications and uses.

In one aspect, the covalent organic frameworks are assembled with a plurality of fused aromatic groups and electron-deficient chromophores as described herein. In one aspect, the organic framework comprises a plurality of structural units comprising the formula I

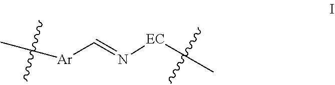

wherein Ar is a fused aromatic group, and
EC is an electron-deficient chromophore.

The squiggle line placed on the bonds in formula I represents a bond to another group (Ar or EC). For example, the structure of formula I is a monomeric unit (i.e., repeat unit) used to produce the organic frameworks described herein. Thus, the formulae described herein where squiggle lines are depicted represent units used to produce the organic framework.

The dimensions and physical properties of the organic framework can vary depending upon the number of structural units as depicted in formula I and the way in which the structural units are arranged in the framework. For example, the structural units of formula I can be positioned to produce the framework with the repeating structure

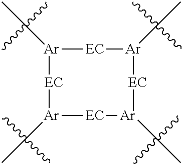

The structure above is represented as a square configuration; however, other configurations can be produced such as, for example three-sided, five-sided, six sided, seven-sided, or eight-sided structures.

The fused aromatic group Ar is a group that possesses two or more aromatic groups that share two carbon atoms. The fused aromatic group can consist entirely of carbon atoms or, in other aspects, can include one or more heteroatoms (e.g., oxygen nitrogen, sulfur, or any combination thereof). In one aspect, the fused aromatic group has from 2 to 10 fused aromatic groups, or 2, 3, 4, 5, 6, 7, 8, 9, or 10 aromatic groups, where any value can be a lower and upper end-point of a ranger (e.g., 2 to 8, 3 to 5, etc.).

In one aspect, the fused aromatic group comprises naphthalene, anthracene, acenaphthene, acenaphthylene, fluorene, phenalene, phenanthrene, benzo[a]anthracene, benzo[a]fluorine, benzo[c]phenanthrene, chrysene, fluoranthene, tetracene, anthanthrene, benzopyrene, pyrene, benzo[a]pyrene, benzo[e]pyrene, benzo[b]fluoranthene, benzo[j]fluoranthene, benzo[k]fluoranthene, corannulene, coronene, dicoronylene, diindenoperylene, helicene, heptacene, hexacene, kekulene, ovalene, pentacene, perylene, picene, or tetraphenylenepentacene. In another aspect, the fused aromatic group comprises a pyrene.

The organic framework comprises a plurality of fused aromatic groups. In one aspect, two or more different fused aromatic groups can be present in the organic framework. In another aspect, the fused aromatic group in the organic framework is the same fused aromatic group (e.g., pyrene).

The fused aromatic group can be substituted with one or more different groups. In one aspect, the fused aromatic group is substituted with one or more aryl groups. In another aspect, the fused aromatic group is substituted with 2 to 8 aryl groups, or 2, 3, 4, 5, 6, 7, or 8 aromatic groups, where any value can be a lower and upper end-point of a ranger (e.g., 2 to 6, 3 to 5, etc.). In one aspect, the aryl groups are symmetrically positioned around the fused aromatic group. In one aspect, the aryl group is the same group bonded to the fused aromatic group; however, two or more different aryl groups can be positioned on each fused aromatic group. In other aspects, the fused aromatic group can include a fused aromatic group substituted with one or more first aryl groups and a second fused aromatic group with one or more second aryl groups, where the first and second aryl groups are different.

In one aspect, the fused aromatic group comprises the structure of formula II

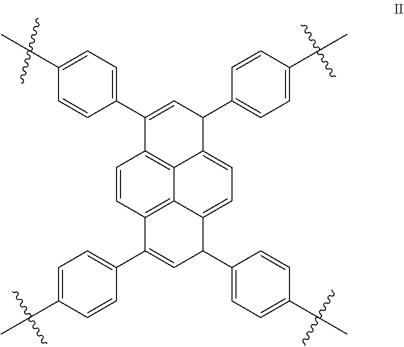 [SMILES: *c1ccc(C2=CC(c3ccc(*)cc3)c3ccc4c5c(ccc2c35)C(c2ccc(*)cc2)=CC4c2ccc(*)cc2)cc1]

Referring to formula II, the fused aromatic group is pyrene, where four phenyl groups (i.e., aryl groups) are symmetrically positioned about the pyrene structure. In one aspect, the organic framework includes only the structure of formula II with respect to the fused aromatic group.

The organic frameworks described herein also include an electron-deficient chromophore. In one aspect, the electron-deficient chromophore comprises a thiadiazole, a triazine, a heptazine, or an oxadiazole. In one aspect, the electron-deficient chromophore comprises a molecule incorporating thiadiazole. Thiadiazole has the structure

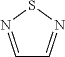

When electron-deficient chromophore includes thiadiazole, thiadiazole can include additional groups that permit covalent bonding to the fused aromatic group as well as enhance the properties of the organic framework. In one aspect, the chromophore can have the structure

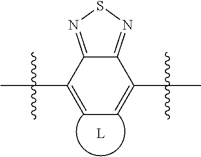

wherein L is not present or L is a fused aromatic group as defined herein comprising 1 to 10 aromatic groups.

In another aspect, the chromophore has the structure of formula III

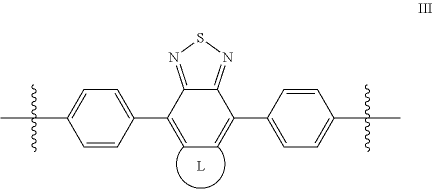

wherein L is not present or L is a fused aromatic group defined herein comprising 1 to 10 aromatic groups.

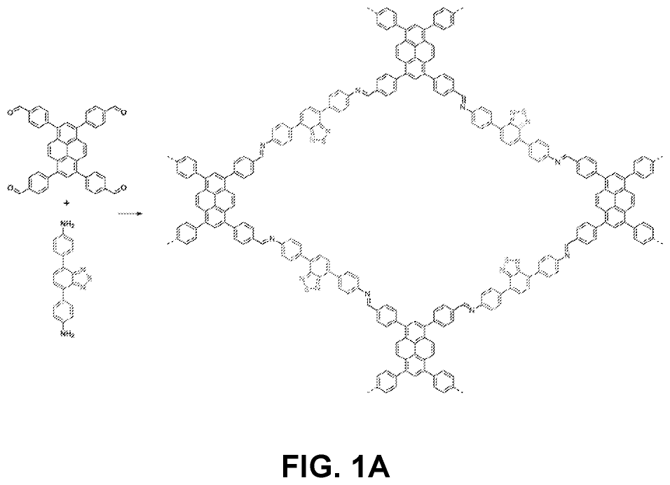

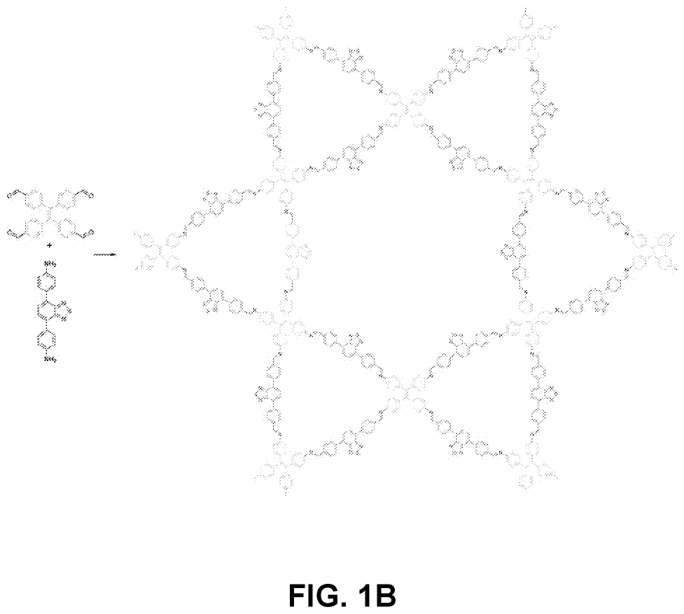

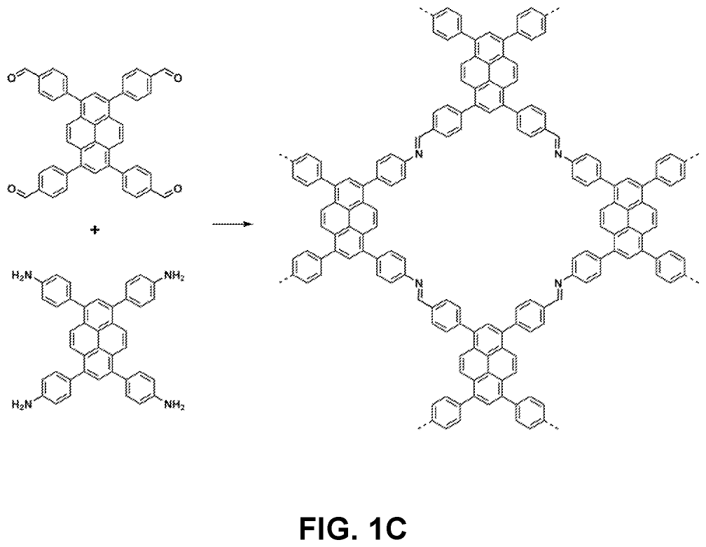

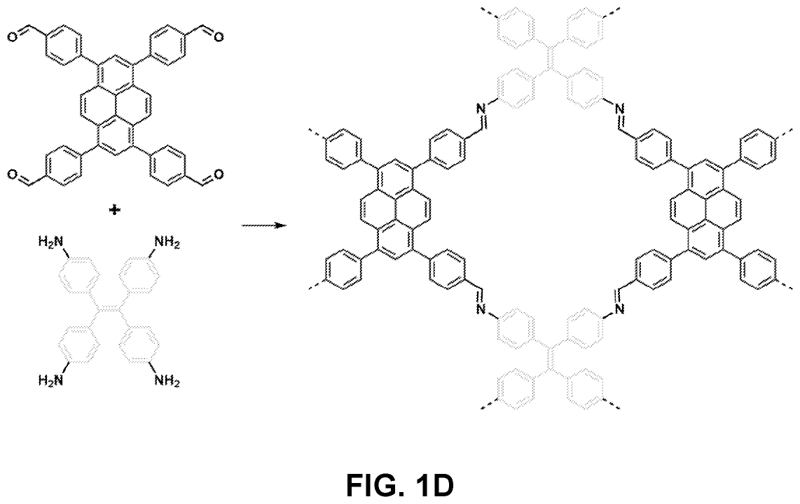

In one aspect, the structural unit used to produce the organic framework has the formula IV

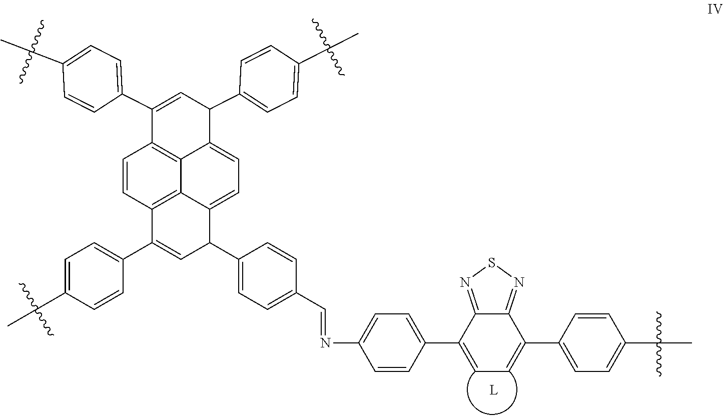

wherein L is not present or L is a fused aromatic group comprising 1 to 10 aromatic groups. In another aspect, the organic framework comprises a plurality structural units having the structure depicted in FIG. 1A.

The structural units present in the organic framework include an imine group (—C═N—) that covalently bonds the fused aromatic group to the electron-deficient chromophore. In one aspect, a Schiff's base reaction can be used to covalently bond the fused aromatic group to the electron-deficient chromophore.

In one aspect, the organic framework is produced by reacting a fused aromatic group substituted with three or more amino groups with an electron-deficient chromophore comprising two aldehyde groups. In one aspect, the fused aromatic group has four amino groups symmetrically positioned around the fused aromatic group. In one aspect, the fused aromatic group is 1,3,6,8-tetrakis(4-aminophenyl)pyrene.

In one aspect, the electron-deficient chromophore comprising two aldehyde groups comprises the formula V

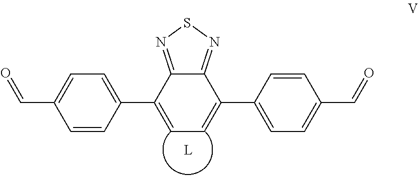

wherein L is not present or L is a fused aromatic group as defined herein comprising 1 to 10 aromatic groups.

In another aspect, the organic framework is produced by reacting a fused aromatic group substituted with three or more aldehyde groups with an electron-deficient chromophore comprising two amino groups. In one aspect, the fused aromatic group has four aldehyde groups symmetrically positioned around the fused aromatic group. In one aspect, the fused aromatic group is 4,4′,4″,4′″-(pyrene-1,3,6,8-tetrayl)tetrabenzaldehyde.

In one aspect, the electron-deficient chromophore comprising two amino groups comprises the formula VI

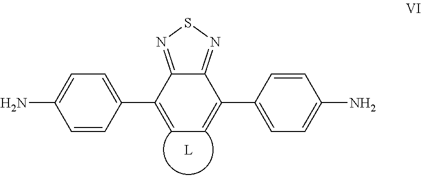

wherein L is not present or L is a fused aromatic group as defined herein comprising 1 to 10 aromatic groups.

Non-limiting procedures for producing organic frameworks described herein are provided in the Examples.

The organic frameworks are crystalline, porous, extended polymers with highly ordered and periodic two-dimensional (2D) or three-dimensional (3D) framework. In one aspect, the organic frameworks described herein comprise an AA stacking structure.

In one aspect, the organic frameworks described herein are two dimensional structures that possess a plurality of square or rhombus channels. In one aspect, the channels have a pore size of about 0.5 nm to about 4 nm, or about 0.5 nm, about 1.0 nm, about 1.5 nm, about 2.0 nm, about 2.5 nm, about 3.0 nm, about 3.5 nm, or about 4.0 nm, where any value can be a lower and upper endpoint of a range (e.g., about 1 nm to about 3.5 nm, about 2 nm to about 3 nm, etc.).

In one aspect, the organic frameworks described herein have a Connolly surface area of about 2,500 m²/g to about 3,000 m²/g, or about 2,500 m²/g, about 2,550 m²/g, about 2,600 m²/g, about 2,650 m²/g, about 2,700 m²/g, about 2,750 m²/g, about 2,800 m²/g, about 2,850 m²/g, about 2,900 m²/g, about 2,950 m²/g, or about 3,000 m²/g, where any value can be a lower and upper endpoint of a range (e.g., about 2,600 m²/g to about 2,900 m²/g, about 2,650 m²/g to about 2,850 m²/g, etc.).

In one aspect, the organic frameworks described herein have a Brunauer-Emmett-Teller (BET) surface area of about 600 m²/g to about 800 m²/g, or about 600 m²/g, about 610 m²/g, about 620 m²/g, about 630 m²/g, about 640 m²/g, about 650 m²/g, about 660 m²/g, about 670 m²/g, about 680 m²/g, about 690 m²/g, 700 m²/g, 710 m²/g to about 720 m²/g, or about 730 m²/g, about 740 m²/g, about 750 m²/g, about 760 m²/g, about 770 m²/g, about 780 m²/g, about 790 m²/g, or 800 m²/g, where any value can be a lower and upper endpoint of a range (e.g., about 610 m²/g to about 790 m²/g, about 650 m²/g to about 750 m²/g, etc.).

In one aspect, the organic frameworks described herein have a total pore volume of about 0.10 cm³/g to about 0.70 cm³/g, or about 0.10 cm³/g, about 0.15 cm³/g, about 0.20 cm³/g, about 0.25 cm³/g, about 0.30 cm³/g, about 0.35 cm³/g, about 0.40 cm³/g, about 0.45 cm³/g, about 0.50 cm³/g, about 0.55 cm³/g, about 0.60 cm³/g, about 0.65 cm³/g, or about 0.70 cm³/g, where any value can be a lower and upper endpoint of a range (e.g., about 0.20 cm³/g to about 0.60 cm³/g, about 0.35 cm³/g to about 0.55 cm³/g, etc.).

### Applications of Frameworks

Due to their unique structures and physical properties, the frameworks described herein can be used in numerous applications. The frameworks described herein possess optoelectronic properties. Not wishing to be bound by theory, the organic frameworks described herein have favorable electron delocalization on the polymeric backbone with extended 7-conjugations and layer stacking architectures, forming periodic columnar 7-arrays with significant electronic overlap.

In one aspect, the organic frameworks described herein can generate singlet oxygen when irradiated. The development of methodologies for efficiently producing ¹O₂ has numerous applications in photodynamic applications. In one aspect, the organic framework can produce singlet oxygen when irradiated by a laser or a xenon lamp at a wavelength of about 200 nm to about 2,000 nm, or about 200 nm, about 300 nm, about 400 nm, about 500 nm about, about 600 nm, about 700 nm, about 800 nm, about 900 nm, about 1,000 nm, about 1,200 nm, about 1,400 nm, about 1,600 nm, or about 2,000 nm, where any value can be a lower and upper endpoint of a range (e.g., about 300 nm to 1,800 nm, about 500 nm to about 800 nm, etc.). The Examples provide techniques for producing and detecting singlet oxygen produced from the organic frameworks described herein.

In one aspect, the frameworks described herein are useful as photocatalysts. In one aspect, described herein are methods for oxidizing an organic compound comprising exposing the organic compound to oxygen in the presence of the organic framework as described herein and irradiating the organic framework.

In one aspect, the organic frameworks described herein can be used to convert toxic chemicals to inert compounds. One such toxic chemical is nerve agents. As one of the most broadly used and notorious chemical weapons, sulfur mustard can cause grievous skin blisters and irritation to the respiratory system or even death at high doses.⁶⁴ In one aspect, the nerve agent is a halo-sulfo compound. In another aspect, the nerve agent is 2-chloroethyl ethyl sulfide or bis(2-chloroethyl) sulfide, diisopropyl phosphorofluoridate, dimethyl methylphosphonate, diethylsulfane, or 3,3-dimethylbutan-2-yl methylphosphonofluoridate. As demonstrated in the Examples, an organic framework oxidized a sulfur mustard simulant 2-chloroethyl ethyl sulfide (CEES) within 1 hour.

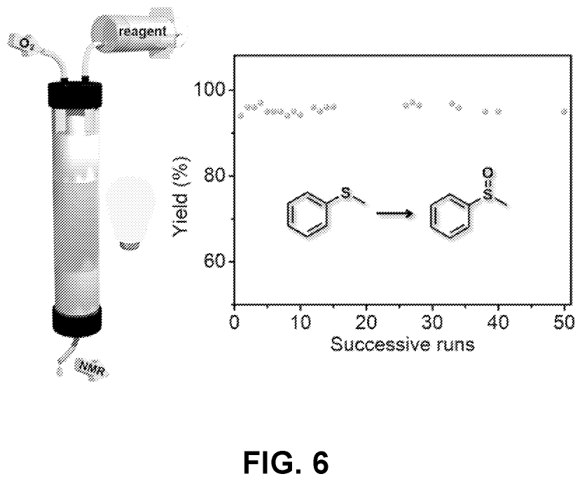

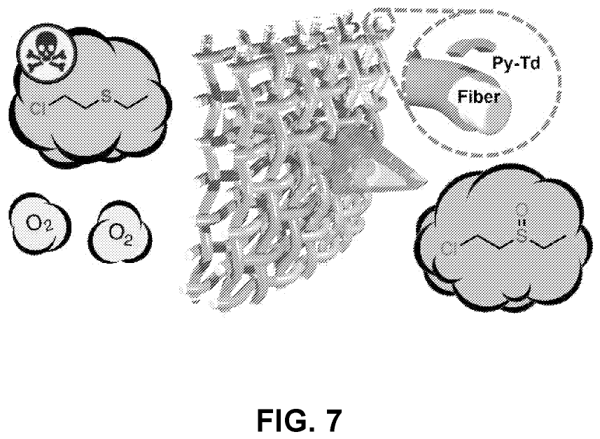

The organic frameworks described herein can be incorporated or used in batch or continuous processes. FIG. 6 provides an example of a continuous flow system that incorporates the organic framework. FIG. 6 depicts a column photoreactor in a continuous flow system, where the organic framework is inserted into the gas column. The organic framework is stable, where multiple runs through the column do not diminish the activity of the organic framework. The Examples provide evidence of the stability of the organic framework when used as a photocatalyst.

Due to the ability of the organic frameworks described herein to oxidize certain organic molecules such as harmful sulfides, the organic frameworks can be applied to fibers used to produce textiles, where the textiles can be worn by personnel that are exposed to harmful compounds such as, for example, mustard gas.

The fibers can be coated with the organic framework using techniques known in the art. In one aspect, the fibers are immersed in a solution of the organic framework then subsequently died. In certain aspect, the fiber can be pre-coated to enhance adhesion of the organic framework to the fiber. In one aspect, the fiber is coated with poly-dopamine followed by coating with the organic framework. Exemplary procedures for producing coated fibers are provided in the Examples. In one aspect, the fiber is a synthetic fiber such as, for example, a polyester, a polyamide (e.g., nylon), a polyalkylene oxide fiber, a glass fiber. In another aspect, the fiber is a natural fiber such as, for example, cotton, wool, or silk.

### Aspects

The following listing of exemplary aspects supports and is supported by the disclosure provided herein.

Aspect 1. An organic framework comprising a plurality of structural units comprising the formula I

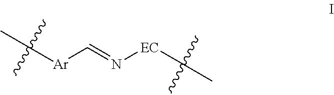

wherein Ar is a fused aromatic group, and

EC is an electron-deficient chromophore.

Aspect 2. The organic framework of claim 1, wherein the fused aromatic group comprises 2 to 10 fused aromatic groups.

Aspect 3. The organic framework according to aspect 1, wherein the fused aromatic group comprises naphthalene, anthracene, acenaphthene, acenaphthylene, fluorene, phenalene, phenanthrene, benzo[a]anthracene, benzo[a]fluorine, benzo[c]phenanthrene, chrysene, fluoranthene, tetracene, anthanthrene, benzopyrene, pyrene, benzo[a]pyrene, benzo[e]pyrene, benzo[b]fluoranthene, benzo[j]fluoranthene, benzo[k]fluoranthene, corannulene, coronene, dicoronylene, diindenoperylene, helicene, heptacene, hexacene, kekulene, ovalene, pentacene, perylene, picene, or tetraphenylenepentacene.

Aspect 4. The organic framework according to aspect 1, wherein the fused aromatic group comprises a pyrene.

Aspect 5. The organic framework according to aspect 1, wherein the fused aromatic group is substituted with 2 to 8 aryl groups.

Aspect 6. The organic framework according to aspect 1, wherein the fused aromatic group comprises the structure of formula II

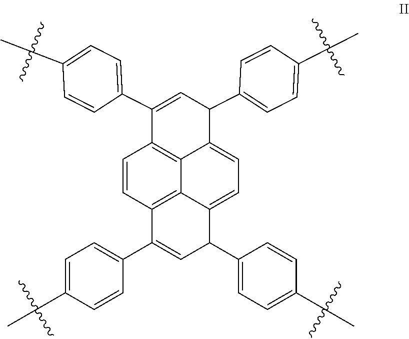 [SMILES: *c1ccc(C2=CC(c3ccc(*)cc3)c3ccc4c5c(ccc2c35)C(c2ccc(*)cc2)=CC4c2ccc(*)cc2)cc1]

Aspect 7. The organic framework according to aspect 1, wherein the electron-deficient chromophore comprises a thiadiazole, a triazine, a heptazine, or an oxadiazole.

Aspect 8. The organic framework according to aspect 1, wherein the electron-deficient chromophore comprises the structure of formula III

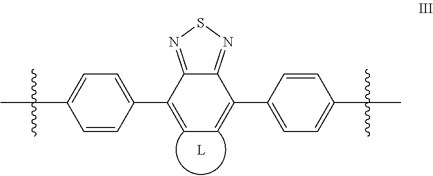

wherein L is not present or L is a fused aromatic group comprising 1 to 10 aromatic groups.

Aspect 9. The organic framework according to aspect 1, wherein the structural unit has the formula IV

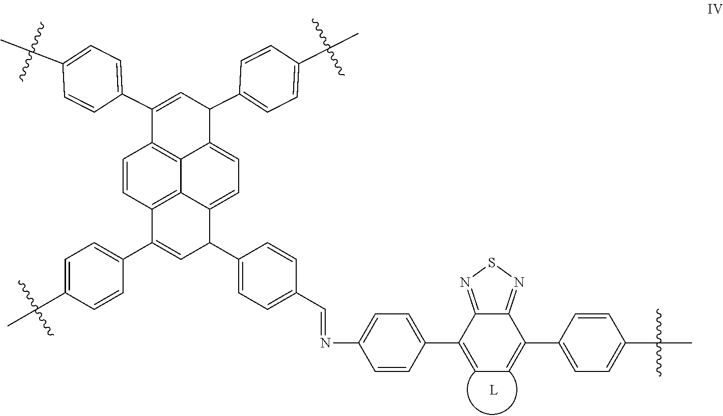

wherein L is not present or L is a fused aromatic group comprising 1 to 10 aromatic groups.

Aspect 10. The organic framework according to aspect 9, wherein L is not present.

Aspect 11. The organic framework according to aspect 1, wherein the framework comprises a plurality structural units having the structure depicted in FIG. 1A.

Aspect 12. An organic framework produced by reacting a fused aromatic group substituted with three or more amino groups with an electron-deficient chromophore comprising two aldehyde groups.

Aspect 13. The organic framework according to aspect 12, wherein the fused aromatic group is 1,3,6,8-tetrakis(4-aminophenyl)pyrene.

Aspect 14. The organic framework according to aspect 12, wherein the electron-deficient chromophore comprising two aldehyde groups comprises the formula V

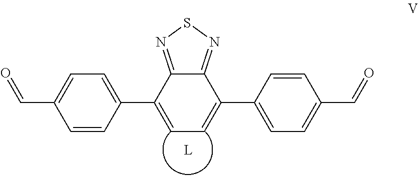

wherein L is not present or L is a fused aromatic group comprising 1 to 10 aromatic groups.

Aspect 15. An organic framework produced by reacting a fused aromatic group substituted with three or more aldehyde groups with an electron-deficient chromophore comprising two amino groups.

Aspect 16. The organic framework according to aspect 15, wherein the fused aromatic group is 4,4′,4″,4′″-(pyrene-1,3,6,8-tetrayl)tetrabenzaldehyde.

Aspect 18. The organic framework according to aspect 15, wherein the electron-deficient chromophore comprising two amino groups comprises the formula VI

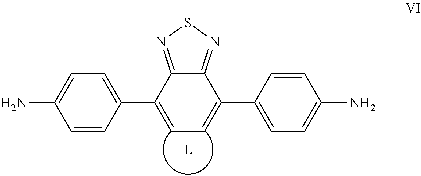

wherein L is not present or L is a fused aromatic group comprising 1 to 10 aromatic groups.

Aspect 18. The organic framework according to any one of aspects 1-17, wherein the framework comprises an AA stacking structure.

Aspect 19. The organic framework according to any one of aspects 1-18, wherein the framework comprises a plurality of channels, wherein the pore size of the channels is from about 0.5 nm to about 4 nm.

Aspect 20. The organic framework according to any one of aspects 1-19, wherein the framework has a Connolly surface area of about 2,500 m²/g to about 3,000 m²/g.

Aspect 21. The organic framework according to any one of aspects 1-20, wherein the framework has a Brunauer-Emmett-Teller (BET) surface area of about 600 m²/g to about 800 m²/g.

Aspect 22. The organic framework according to any one of aspects 1-21, wherein the framework has a total pore volume of about 0.1 cm³/g to about 0.7 cm³/g.

Aspect 23. The use of the organic framework according to any one of aspects 1-22 as a photocatalyst.

Aspect 24. A method for generating singlet oxygen, the method comprising irradiating the organic framework according to any one of aspects 1-22.

Aspect 25. The method according to aspect 24, wherein the organic framework is irradiated by a laser or a xenon lamp.

Aspect 26. The method according to aspects 24 or 25, wherein the organic framework is irradiated at a wavelength of about 200 nm to about 2,000 nm.

Aspect 27. A method for oxidizing an organic compound, comprising exposing the organic compound to oxygen in the presence of the organic framework according to any one of aspects 1-22 and irradiating the organic framework.

Aspect 28. The method according to aspect 27, wherein the organic compound is a diene or sulfide.

Aspect 29. The method according to aspects 27 or 28, wherein the method is conducted in a batch process or continuous process.

Aspect 30. A fiber comprising a coating of the organic framework according to any one of aspects 1-22.

Aspect 31. The fiber according to aspect 30, wherein the fiber comprises a synthetic fiber.

Aspect 32. The fiber according to aspect 31, wherein the synthetic fiber comprises a polyester, a polyamide, a polyalkylene oxide fiber, a glass fiber.

Aspect 33. The fiber according to aspect 30, wherein the fiber comprises a natural fiber.

Aspect 34. The fiber according to aspect 33, wherein the natural fiber comprises cotton, wool, or silk.

### Examples

The following examples are put forth so as to provide those of ordinary skill in the art with a complete disclosure and description of how the compounds, compositions, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. Numerous variations and combinations of reaction conditions (e.g., component concentrations, desired solvents, solvent mixtures, temperatures, pressures, and other reaction ranges and conditions) can be used to optimize the product purity and yield obtained from the described process. Only reasonable and routine experimentation will be required to optimize such process conditions.

### Chemicals

Solvents were purified according to standard laboratory methods. Other commercially available reagents were purchased in high purity and used without further purification.

### Material Synthesis

### Synthesis of 1,3,6,8-tetrakis(4-aminophenyl)pyrene [Py(NH₂)₄]

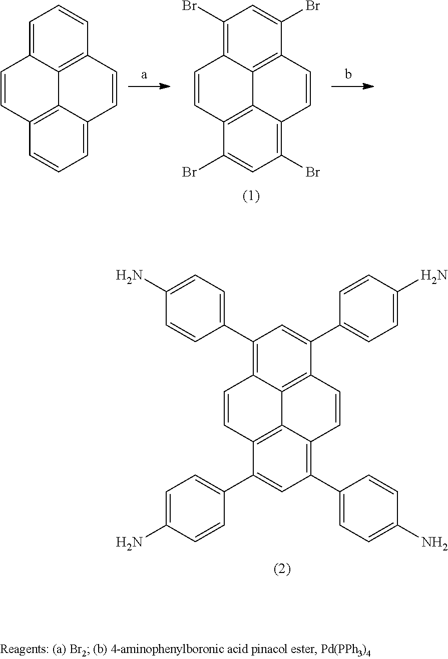

1,3,6,8-tetrabromopyrene (1): To a mixture of pyrene (5.05 g, 25.0 mmol) and nitrobenzene (200 mL), Br₂ (110 mmol in 100 mL of nitrobenzene) was added dropwise. After the addition was complete, the resulting yellow suspension was heated at 120° C. for 18 h and then cooled to room temperature. The precipitate was filtered off, washed with ethanol, and dried under vacuum to yield 1,3,6,8-tetrabromopyrene as a pale yellow solid. The product was found to be insoluble in all common organic solvents, limiting characterization.

1,3,6,8-tetrakis(4-aminophenyl)pyrene (2): 1,3,6,8-tetrabromopyrene (2.96 g, 5.72 mmol), 4-aminophenylboronic acid pinacol ester (6.0 g, 27.4 mmol), K₂CO₃ (4.4 g, 31.6 mmol), and Pd(PPh₃)₄ (0.66 g, 0.589 mmol) were introduced into a mixture of 1,4-dioxane (100 mL) and H₂O (20 mL). The resulting mixture was refluxed under N₂ atmosphere for 3 d. After cooling to room temperature, the solution was poured into water. The formed precipitate was filtered off, and washed with water and methanol, which was further purified by flash chromatography with acetone as eluent to afford the title compound as a yellow-brown solid. ¹H NMR (400 MHz, d₆-DMSO, 298K, TMS): δ 8.13 (s, 4H), 7.79 (s, 2H), 7.35 (d, 8H, J=8.4 Hz), 6.77 (d, 8H, J=8.0 Hz), 5.32 (s, 8H) ppm.

### Synthesis of 4,4′,4″,4′″-(pyrene-1,3,6,8-tetrayl)tetrabenzaldehyde [Py(CHO)₄]

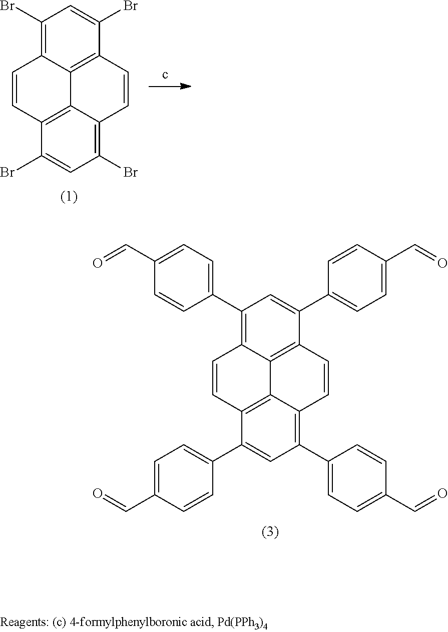 [SMILES: Brc1cc(Br)c2ccc3c(Br)cc(Br)c4ccc1c2c43 ; O=Cc1ccc(-c2cc(-c3ccc(C=O)cc3)c3ccc4c(-c5ccc(C=O)cc5)cc(-c5ccc(C=O)cc5)c5ccc2c3c54)cc1]

4,4′,4″,4′″-(pyrene-1,3,6,8-tetrayl)tetrabenzaldehyde. 1,3,6,8-tetrabromopyrene (2.96 g, 5.72 mmol), 4-formylphenylboronic acid (4.12 g, 27.4 mmol), K₂CO₃ (4.4 g, 31.6 mmol), and Pd(PPh₃)₄ (0.66 g, 0.58 mmol) were introduced into 1,4-dioxane (100 mL). The resulting mixture was refluxed under N₂ atmosphere for 3 d. After cooling to room temperature, the solution was poured into water. The formed precipitate was filtered off, and washed with water and acetone. After dying, the resulting solid was Soxhlet extracted with chloroform for one weak. The title product was obtained as a yellow solid after evaporating CHCl₃. ¹H NMR (400 MHz, CDCl₃, 298K, TMS): δ 10.17 (s, 4H), 8.18 (s, 4H), 8.10 (d, 8H, J=8.0 Hz), 8.05 (d, 2H), 7.86 (d, 8H, J=8.0 Hz) ppm.

### Synthesis of 1,1,2,2-tetrakis(4-aminophenyl)ethane (Etta)

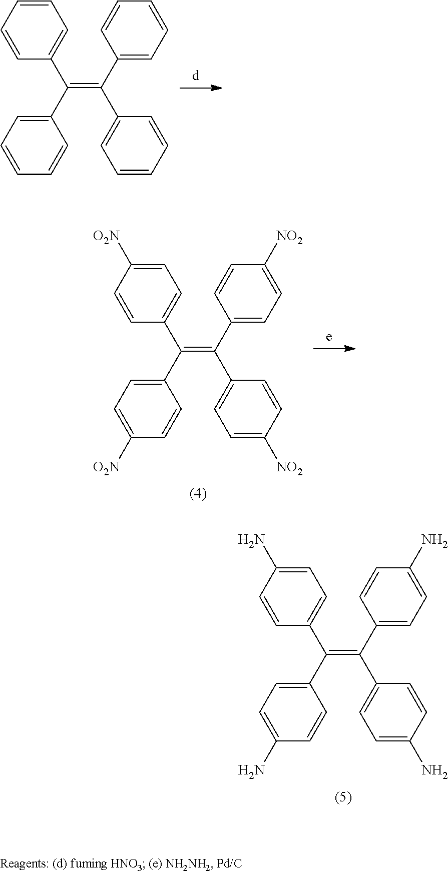

1,1,2,2-tetrakis(4-nitrophenyl)ethane (4): To a solution of fuming nitric acid (40 mL) and acetic acid (40 mL) at 0° C., 1,1,2,2-tetraphenylethene (5 g) was added in portions. The resulting mixture was allowed to warm to RT and stirred for another 3 h. The solution was poured into ice water and the precipitate was filtered off, washed with water and recrystallized from 1,4-dioxane to yield 4 as yellow crystals. ¹H NMR (400 MHz, d₆-DMSO, 298K, TMS) δ 8.1 (d, 8H, J=8.0 Hz), 7.36 (d, 8H, J=8.4 Hz).

1,1,2,2-tetrakis(4-aminophenyl)ethane (5): A suspension of 1,1,2,2-tetrakis(4-nitrophenyl)ethane (2.5 g, 4.88 mmol) and Pd/C (5 wt. %, 0.25 g) in ethanol (80 mL) was heated to reflux. Hydrazine hydrate (15 mL) was added dropwise, and the mixture was refluxed overnight. The hot solution was filtered through Celite and all volatiles were evaporated under vacuum, yielding the title compound as a yellow powder. ¹H NMR (400 MHz, d₆-DMSO, 298K, TMS): δ 6.57 (s, 8H), 6.26 (d, 8H, J=8.0 Hz), 4.86 (s, 8H) ppm.

### Synthesis of 4,4′-(benzo[c][1,2,5]thiadiazole-4,7-diyl)dianiline (TdNH₂)

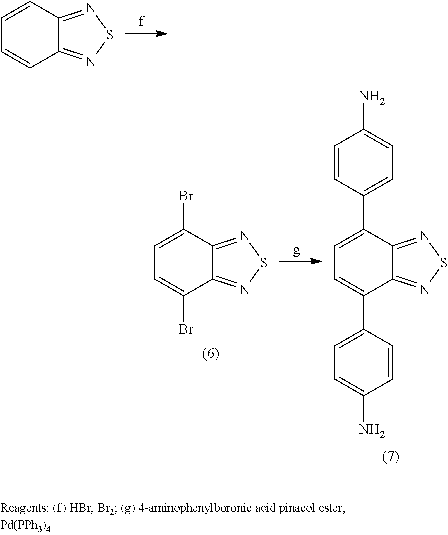 [SMILES: c1ccc2nsnc2c1 ; Brc1ccc(Br)c2nsnc12 ; Nc1ccc(-c2ccc(-c3ccc(N)cc3)c3nsnc23)cc1]

4,7-dibromobenzo[c][1,2,5]thiadiazole (6). A solution of Br₂ (35.2 g, 220.3 mmol) in HBr (100 mL) was added dropwise to the mixture of benzothiadiazole (10.0 g, 73.4 mmol) and HBr (150 mL, 48 wt. %). The resulting mixture was heated at reflux for 6 h, yielding a dark orange solid. The mixture was cooled to RT and poured to a NaHSO₃ saturated solution to consume any excess Br₂. The resulting mixture was filtered and washed exhaustively with water. The obtained solid was then washed with cold Et₂O and dried under vacuum to afford 6 as a light yellow solid. ¹H NMR (400 MHz, d₆-DMSO, 298K, TMS): δ 7.92 (s, 2H) ppm.

4,4′-(benzo[c][1,2,5]thiadiazole-4,7-diyl)dianiline (7). 6 (1.67 g, 5.7 mmol), 4-aminophenylboronic acid pinacol ester (3.0 g, 13.7 mmol), Pd(PPh₃)₄ (0.23 g, 0.2 mmol), and K₂CO₃ (3.8 g, 27.4 mmol) were introduced into the mixture of 1,4-dioxane (60 mL) and H₂O (10 mL). The resulting mixture was stirred at 110° C. for 3 d under N₂ atmosphere. The residue was extracted with ethyl acetate, washed with brine, dried over Na₂SO₄, and evaporated under reduced pressure, giving the crude compound which was purified by flash chromatography with hexane/ethyl acetate (1:1) as eluent to afford the title compound as a yellow solid. ¹H NMR (400 MHz, CDCl₃, 298K, TMS): δ 7.74 (d, 4H, J=8.4 Hz), 7.60 (s, 2H), 6.77 (d, 4H, J=8.4 Hz) ppm.

### Synthesis of 4,4′-(benzo[c][1,2,5]thiadiazole-4,7-diyl)dibenzaldehyde (TdCHO)

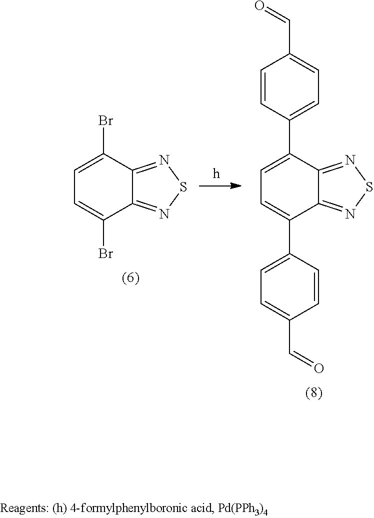 [SMILES: Brc1ccc(Br)c2nsnc12 ; O=Cc1ccc(-c2ccc(-c3ccc(C=O)cc3)c3nsnc23)cc1]

4,4′-(benzo[c][1,2,5]thiadiazole-4,7-diyl)dibenzaldehyde (6) (1.67 g, 5.7 mmol), 4-formylphenylboronic acid (2.06 g, 13.7 mmol), Pd(PPh₃)₄ (0.23 g, 0.2 mmol), and K₂CO₃ (3.8 g, 27.4 mmol) were introduced into the mixture of 1,4-dioxane (60 mL) and H₂O (10 mL). The resulting mixture was stirred at 110° C. for 3 d under N₂ atmosphere. The residue was extracted with dichloromethane, washed with brine, dried over Na₂SO₄, and evaporated under reduced pressure, giving the crude compound which was purified by flash chromatography with hexane/dichloromethane (2:3) as eluent to afford the title compound as a red solid. ¹H NMR (400 MHz, d₆-DMSO, 298K, TMS): δ 10.06 (d, 2H, J=17.2 Hz), 8.24 (d, 2H, J=8.0 Hz), 8.00-8.07 (m, 4H), 7.92 (d, 2H, J=7.6 Hz), 7.48-7.68 (m, 2H) ppm.

### Synthesis of Py-Td (FIG. 1A)

A Schlenk tube (5 mL) was charged with 3 (20.6 mg, 0.033 mmol) and 7 (21.2 mg, 0.066 mmol) in 1.1 mL of a 5:5:1 v/v/v solution of 1,2-dichlorobenzene/n-butylalcohol/6 M aqueous acetic acid. The tube was flash frozen at 77 K (liquid N₂ bath), evacuated, and sealed. The reaction mixture was heated at 120° C. for 3 days to afford a red brick precipitate which was isolated by filtration and washed with anhydrous CHCl₃ using Soxhlet extraction for 3 d. The product was dried under vacuum to afford the Py-Td COF. CHN calculated for C₄₀H₂₃N₄S: C, 81.2; H, 3.9; N, 9.5%. Found: C, 80.5; H, 4.0; N, 9.4%.

### Synthesis of Etta-Td (FIG. 1B)

A Schlenk tube (5 mL) was charged with 5 (19.6 mg, 0.05 mmol) and 8 (34.4 mg, 0.1 mmol) in 1.1 mL of a 5:5:1 v/v/v solution of 1,2-dichlorobenzene/n-butylalcohol/6 M aqueous acetic acid. The tube was flash frozen at 77 K (liquid N₂ bath), evacuated, and sealed. The reaction mixture was heated at 120° C. for 3 days to afford an orange-red precipitate which was isolated by filtration and washed with anhydrous THF using Soxhlet extraction for 3 d. The product was dried under vacuum to afford the Etta-Td COF. The product was dried under vacuum to afford the Py-Td COF. CHN calculated for C₁₆H₁₀NS: C, 76.7; H, 4.4; N, 8.0%. Found: C, 76.2; H, 4.6; N, 7.8%.

### Synthesis of Py-Py (FIG. 1C)

A Schlenk tube (5 mL) was charged with 2 (28.3 mg, 0.05 mmol) and 3 (30.9 mg, 0.05 mmol) in 1.1 mL of a 5:5:1 v/v/v solution of 1,2-dichlorobenzene/n-butylalcohol/6 M aqueous acetic acid. The tube was flash frozen at 77 K (liquid N₂ bath), evacuated, and sealed. The reaction mixture was heated at 120° C. for 3 days to afford an orange precipitate which was isolated by filtration and washed with anhydrous CHCl₃ using Soxhlet extraction for 3 d. The product was dried under vacuum to afford the Py-Py COF. The product was dried under vacuum to afford the Py-Py COF. CHN calculated for C₂₁H₁₂N: C, 90.6; H, 4.4; N, 5.0%. Found: C, 90.5; H, 4.6; N, 4.8%.

### Synthesis of Etta-Py (FIG. 1D)

A Schlenk tube (10 mL) was charged with 3 (75.6 mg, 0.24 mmol) and 5 (48.0 mg, 0.12 mmol) in 2.2 mL of a 5:5:1 v/v/v solution of 1,2-dichlorobenzene/n-butylalcohol/6 M aqueous acetic acid. The tube was flash frozen at 77 K (liquid N₂ bath), evacuated, and sealed. The reaction mixture was heated at 120° C. for 3 days to afford a yellow precipitate which was isolated by filtration and washed with anhydrous CHCl₃ using Soxhlet extraction for 3 d. The product was dried under vacuum to afford the Etta-Py COF. The product was dried under vacuum to afford the Etta-Py COF. CHN calculated for C₃₅H₂₁N₂: C, 89.5; H, 4.5; N, 6.0%. Found: C, 98.5; H, 4.9; N, 5.9%.

### Synthesis of Py-Td-POP

To the mixture of 3 (50 mg, 0.08 mmol) and 7 (51.4 mg, mmol) in a Schlenk tube, DMSO (4 mL) was introduced. After being stirred at room temperature for 12 h and then 120° C. for 3 d, the title product was isolated by filtration, washed with anhydrous CHCl₃ using Soxhlet extraction for 3 d, and dried under vacuum at 50° C. The product was dried under vacuum to afford the Py-Td COF. CHN calculated for C₄₀H₂₃N₄S: C, 81.2; H, 3.9; N, 9.5%. Found: C, 80.3; H, 4.1; N, 9.3%.

### Synthesis of Py-Td Coated Melamine Foam and Nylon-66 Fabric

To achieve the title composite materials, the melamine foam and nylon-66 fabric were coated with a layer of poly-dopamine, by soaking in a dopamine Tris-HCl solution (pH=8.5) for 24 h. After that, the substrates were filtered, rinsed with deionized water and acetone, and dried under vacuum to yield the poly-dopamine coated materials. The Py-Td COF crystals coated melamine foam/nylon-66 fabric was achieved by immersion the corresponding poly-dopamine coated materials into the Py-Td COF synthetic system as described above.

### Catalytic Evaluation

General Procedure for Photocatalytic Transformation of α-Terpinene to Ascaridole. A Schlenk tube (5 mL) was charged with CHCl₃ (1 mL), α-terpinene (1 mmol), and photocatalyst (5 mg). The mixture was saturated with 02, and magnetically stirred at room temperature under irradiation of blue LED modules with a power of 10 W/m (total 10 W). Once the reaction was completed, the photocatalyst was collected by centrifugation and the solvent was removed under vacuum. The yields were determined by ¹H NMR.

General Procedure for Photocatalytic Oxidation of Sulfides. A Schlenk tube (5 mL) was charged with CH₃CN (1 mL), sulfides (5 μL), and photocatalyst (5 mg). The mixture was saturated with 02 and magnetically stirred at room temperature under irradiation of 280 W white Xe lamp. Once the reaction was completed, the photocatalyst was collected by centrifugation, and the solvent was removed under vacuum. The conversions and selectivity were determined by ¹H NMR on the basis of the ratio between integrated peaks of products and substrate after dissolving in CDCl₃.

General Procedure for Photocatalytic Reactions in Flow Employing Py-Td. The fix-bed reaction system was prepared as follows: 0.5 g of silica gel was placed at the bottom of the glass column, and then the mixture of 20 mg of Py-Td and 1 g of silica gel (200 mesh) was introduced, which was covered by another 0.5 g of silica gel. The column was fitted to a light source, and the solution was pumped through the column at 1.0 mL h⁻¹. Concurrently, oxygen was pumped through a second pump at a flow rate of 1 mL min⁻¹. The solution was collected at an interval of 1 h, and the yield was analyzed by ¹H NMR.

### DFT Calculations

The Natural Transition Orbital (NTO) particle-hole representation of the repeat units of COF materials (Py-Td, Etta-Td, Py-Py, and Etta-Py from top to bottom, respectively), were optimized with B3LYP/6-31 G(d) basis set implemented in Gaussian 09 program package.

The density functional theory (DFT) calculations associated with band structure were carried out by CASTEP. [Cryst. Mater. 2005, 220, 567-570.] The generalized gradient approximation (GGA) of Perdew-Burke-Ernzerhof (PBE) [Phys. Rev. Lett. 1996, 77, 3865-3868.] was used, and dispersion interaction was considered by Grimme's DFT-D correction [J. Chem. Phys. 2010, 132, 154104.] during the geometrical optimization with Gamma point (1×1×1) for Brillounin Zone integrations. In the band structure and density of state calculations, the 1×1×2 (Etta-Td) and 3×1×1 (Py-Td) Monkhorst-Pack grid was utilized for Brillounin Zone integrations along with ultrasoft pseudopotentials. The SCF tolerance was set as 5×10⁻⁷ eV/atom, and the energy, force, stress, and displacement were converged to 5×10⁻⁶ eV/atom, 0.01 eV/A, 0.02 GPa and 5×10⁻⁶ Å during the optimization.

### Electrochemical Characterization

The Mott-Schottky plots were carried out with a CHI660E workstation (ShangHai ChenHua, China) via a conventional three-electrode system in a 0.2 M Na₂SO₄ aqueous solution. The working electrode was prepared as follows: A COF material (2 mg) was dispersed in a mixed solution of ethanol (1 mL) and Nafion D-520 (10 μL) to form a homogeneous slurry. Subsequently, 200 μL of the slurry was transferred and coated on an ITO glass plate (1 cm×2 cm), and then dried at room temperature. The Ag/AgCl electrode was employed as the reference electrode, and a platinum plate was used as the counter electrode, respectively.

Cyclic Voltammetry: The working electrode was prepared by drop casting an ethanol suspension of the COF material, carbon black, and polytetrafluoroethylene (PTFE) (2:7:1 by weight) onto a glassy carbon electrode. Tetrabutylammonium hexafluorophosphate (0.1 M, acetonitrile) was used as an electrolyte. The counter and reference electrodes were Pt wire and Ag/AgNO₃. Ferrocene was used as a standard to calculate the energy levels vs. vacuum.

### Electron Paramagnetic Resonance (EPR) Characterization

Powder samples: Approximately 1 mg of Py-Td was loaded in a borosilicate capillary tube (0.70 mm i.d./1.25 mm o.d.; VitroGlass, Inc.). Both ends of the tube were sealed with wax. The sealed sample was then mounted in a Varian E-109 spectrometer fitted with a cavity resonator. The continuous wave (CW) EPR spectrum was acquired with an observe power of 12.5 mW and modulation amplitude of 2 G. The main frequency is 9.550 GHz. The scan range is 100 G, from 3300 G to 3400 G. Signal average time is about 20 min. The sealed sample was then irradiated with a 457 nm visible lamp for 60 min, followed by the same EPR studies.

Spin trapping studies for O₂.⁻ detection: Approximately 1 mg of Py-Td was suspended in 50 μL of acetonitrile containing 50 mM DMPO and loaded in a borosilicate capillary tube. Both ends of the tube were sealed with wax. The sealed sample was then irradiated for 60 min, followed by mounting in a Varian E-109 spectrometer fitted with a cavity resonator. The continuous wave (CW) EPR spectrum was acquired with an observe power of 12.5 mW and modulation amplitude of 2 G. The main frequency is 9.550 GHz. The scan range is 100 G, from 3300 G to 3400 G. Signal average time is around 20 min.

Spin trapping studies for ¹O₂ detection: The experiments were performed followed the same procedures as for O₂.⁻ detection except that 50 mM TEMP was used instead of 50 mM DMPO.

### Structure Simulation

The crystalline structures of the COFs were constructed using Materials Studio and the geometry and unit cell were optimized by Forcite method. Universal force field and Quasi-Newton algorithm were used for calculation. The XRD pattern simulations were performed in a software package for crystal determination from PXRD pattern, implemented in MS modeling. We performed Pawley refinement to optimize the lattice parameters iteratively until R_{WP} value converges. The pseudo-Voigt profile function was used for whole profile fitting and Berrar-Baldinozzi function was used for asymmetry correction during the refinement processes. The final R_{WP} value was 2.1, 5.6, 5.8, and 7.0 for Py-Td, Py-Py, Etta-Py, and Etta-Td, respectively.

### Results

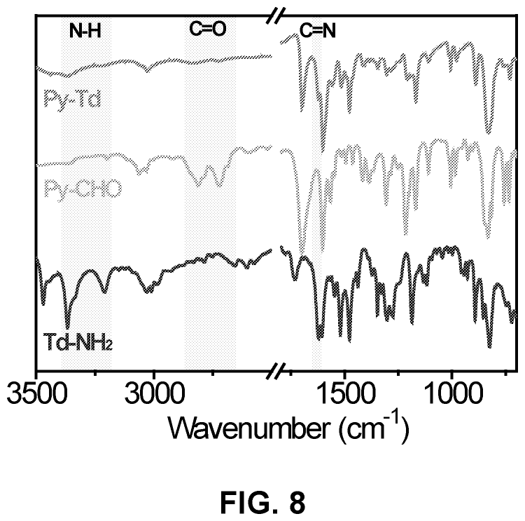

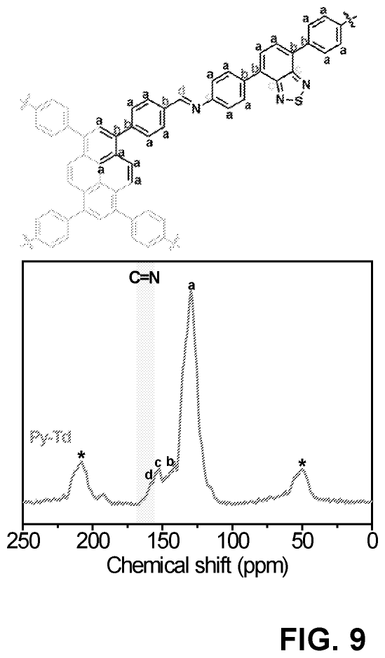

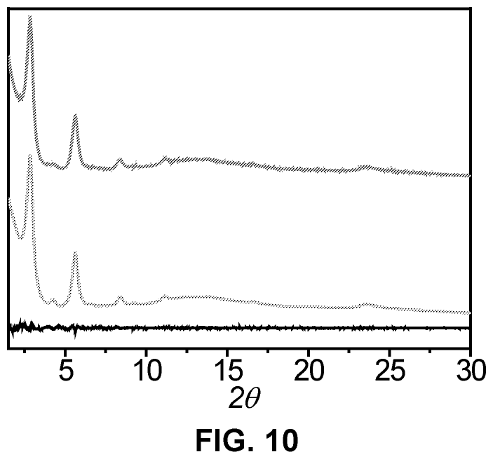

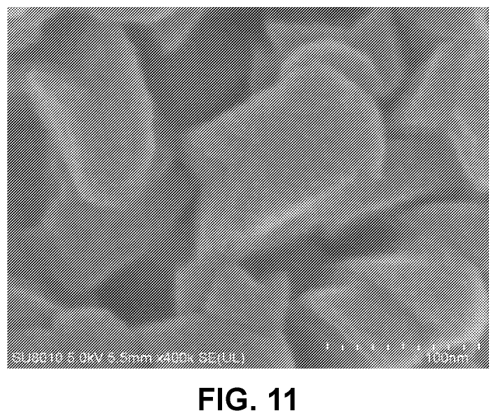

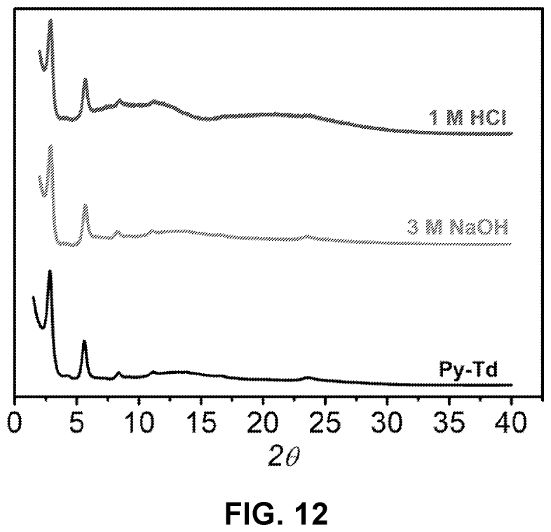

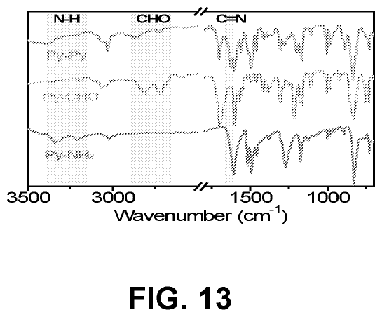

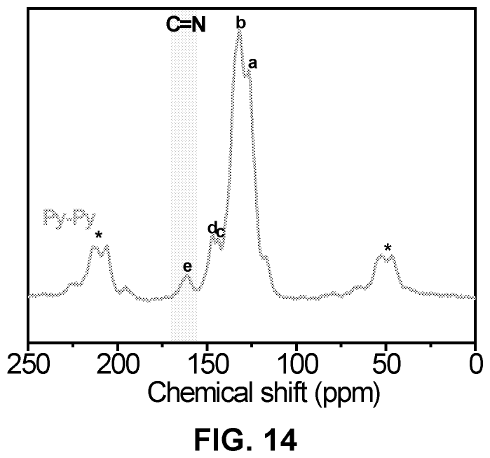

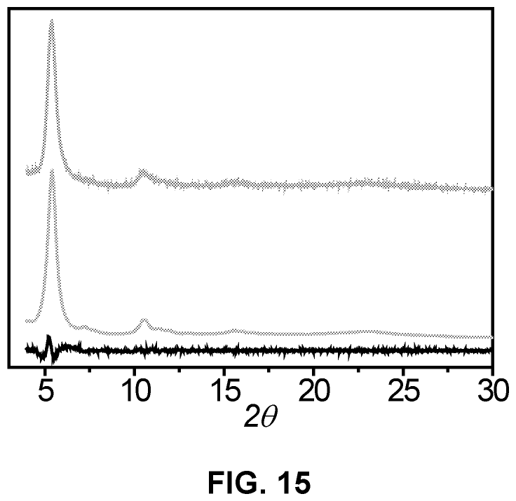

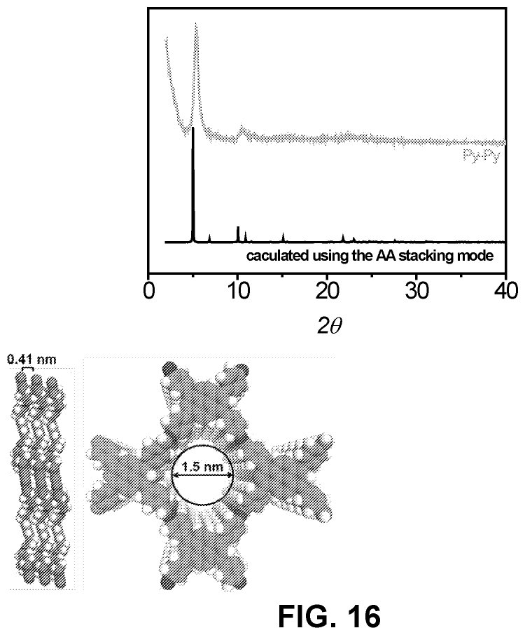

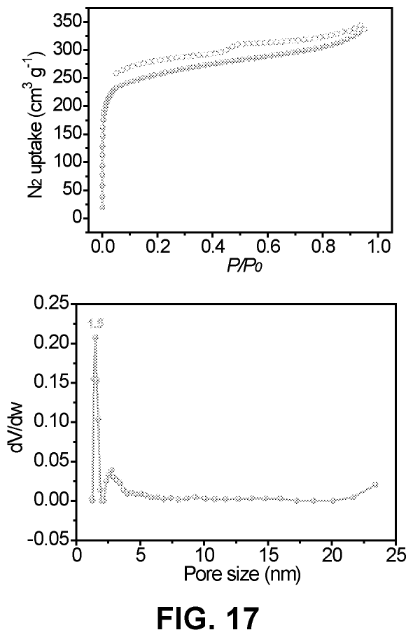

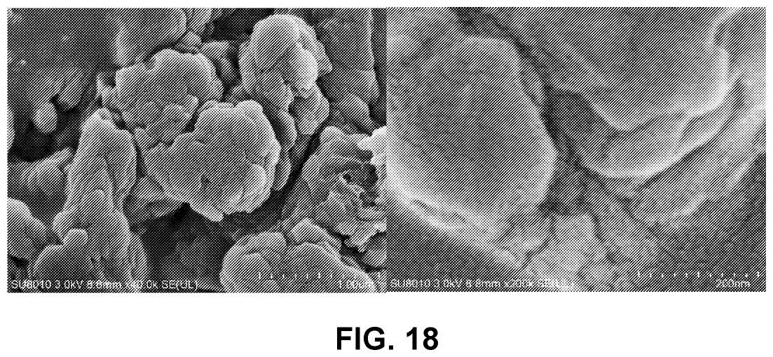

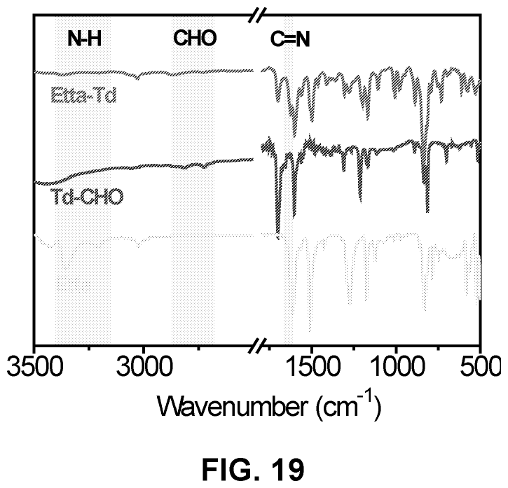

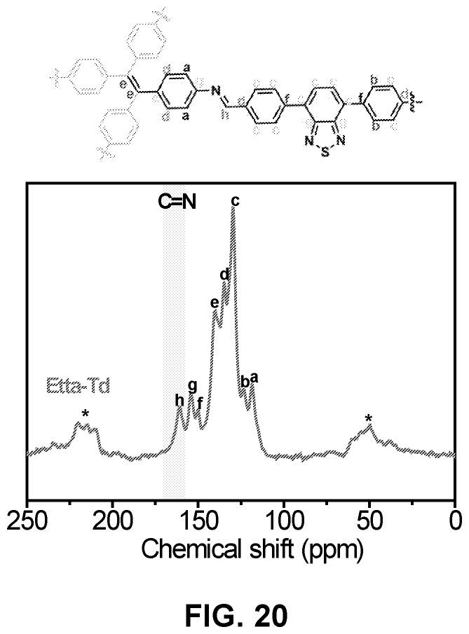

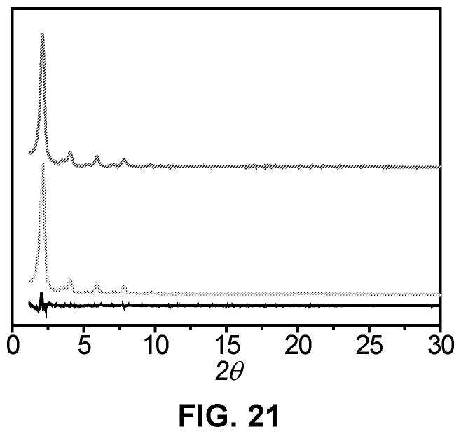

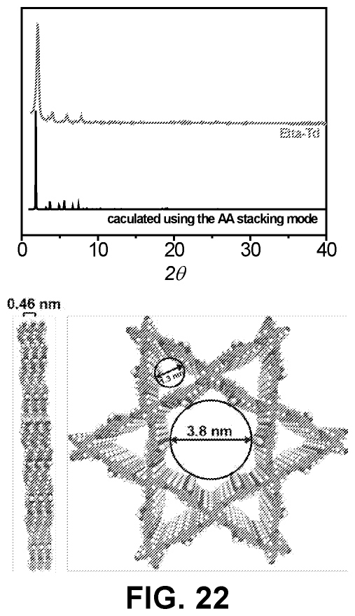

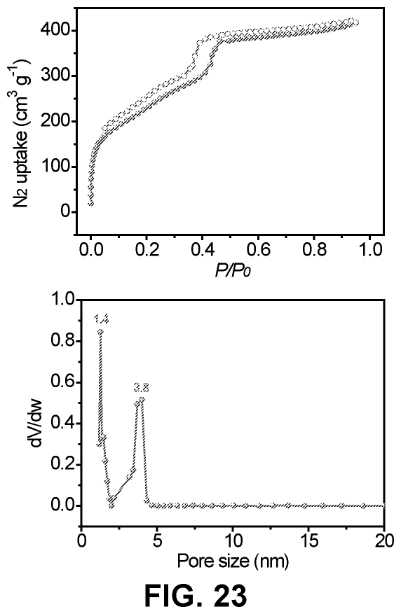

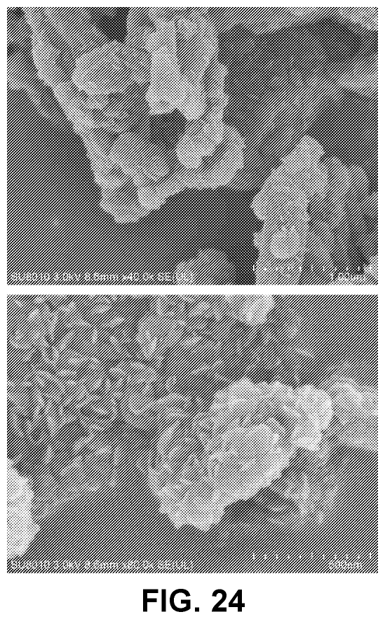

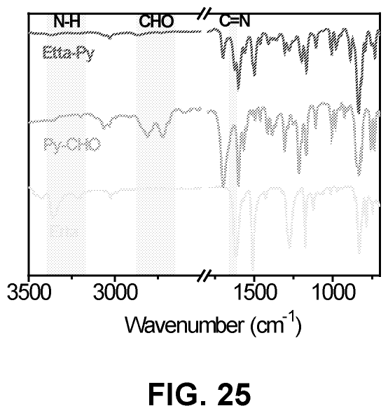

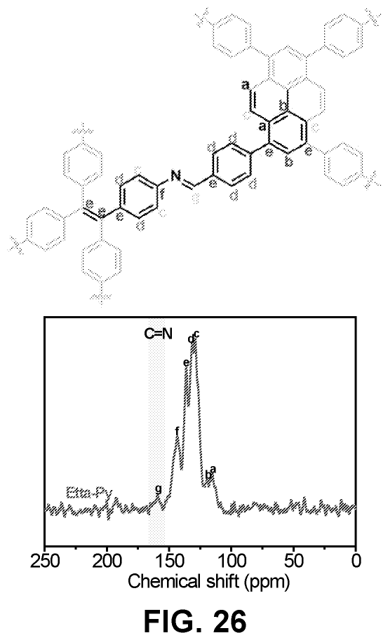

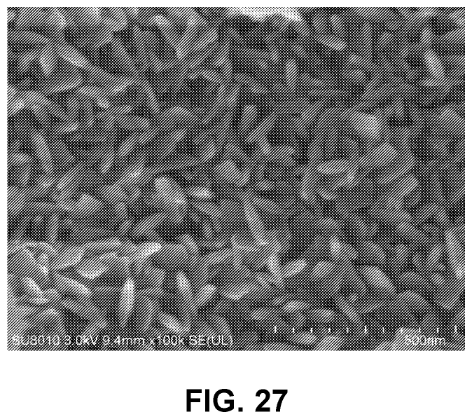

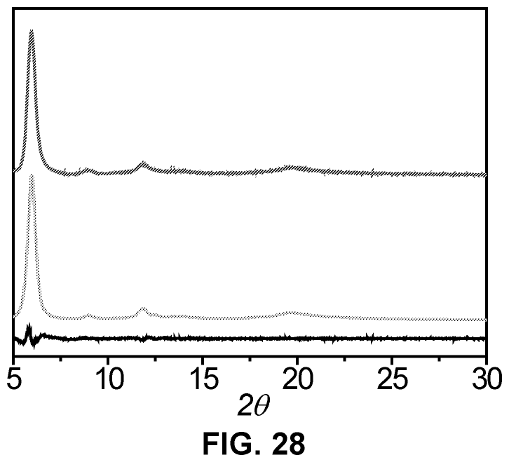

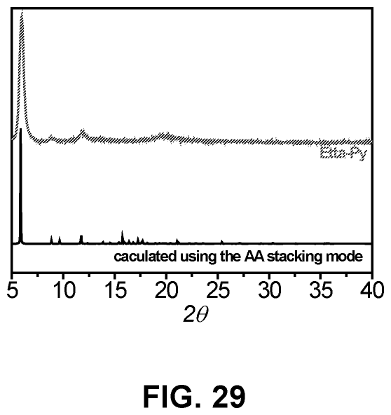

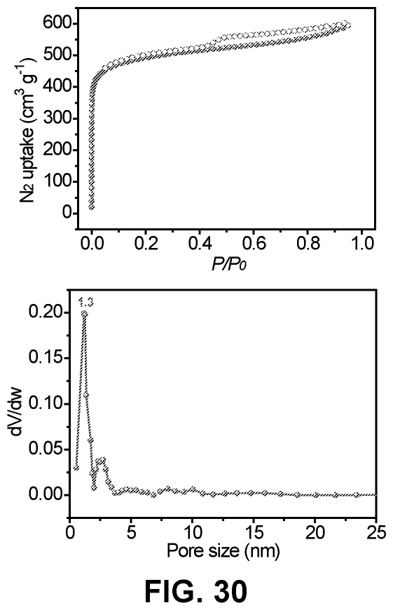

Physiochemical Characterization and Local Structure Analysis. These materials were synthesized under acid-catalyzed solvothermal conditions. The formation of the imine linkage in all synthesized COFs was verified by Fourier-transform infrared spectroscopy (FT-IR), where we observed the appearance of characteristic C═N stretching modes at 1620 cm⁻¹, as well as a complete disappearance of N—H stretching of the primary amines (3370-3210 cm⁻¹) and aldehyde band (2800-2720 cm⁻¹) from the monomers (FIG. 8). Solid-state ¹³C NMR spectra showing a peak at around 160 ppm, in line with the C═N bond, provide additional evidence of the formation of the imine linkage. Detailed characterization of Py-Td, Py-Py, Etta-Py, and Etta-Td, are provided in FIGS. 13-30 and Table 1 below.

TABLE 1
Textural parameters of the synthesized materials.

| | Connolly | | | Pore |
|---|---|---|---|---|
| | surface area^{a} | BET | Pore size | volume |
| Materials | (m² g⁻¹) | (m² g⁻¹) | (nm) | (cm³ g'¹) |
| Py-Td | 2843 | 672 | 2.54 | 0.40 |
| Py-Py | 1756 | 958 | 1.5 | 0.52 |
| Etta-Py | 2754 | 1858 | 1.3 | 0.92 |
| Etta-Td | 2843 | 749 | 1.4 and 3.8 | 0.64 |
| Py-Td-POP | — | 477 | | 0.37 |

^{a}The Connolly surface area was determined by Platon.

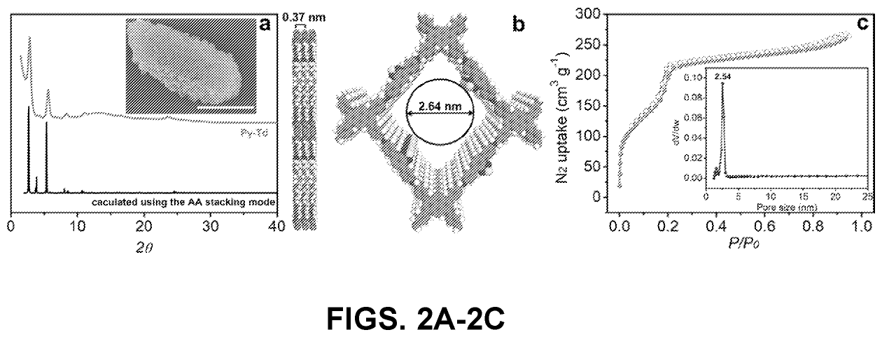

The powder X-ray diffraction (PXRD) pattern of Py-Td contains several prominent diffraction peaks, indicating the high crystallinity of the material. The identification of the resulting structure was done through a comparison of structures modeled using Materials Studio (FIG. 2a). The corresponding powder patterns were simulated based on the optimized CM symmetric structure model and compared with the experimentally obtained data, which showed good agreement between each other (FIG. 2b). Pawley refinement of the PXRD pattern was carried out for full profile fitting against the proposed model of AA packing, which resulted in good agreement factors (R_{WP}=2.1 after convergence) and reasonable profile differences (Figure S3 and Table 6 at the end of the Examples). The morphology of Py-Td was examined using scanning electron microscopy (SEM), with the majority showing pill-shaped aggregates of irregular polyhedral particles, suggestive of phase purity (FIG. 2a, inset). Nitrogen sorption isotherms of Py-Td collected at 77 K revealed that it formed a porous structure with distinguishable mesopores. The Brunauer-Emmett-Teller (BET) surface area and pore volume were estimated to be 672 m² g⁻¹ and 0.40 cm³ g⁻¹, respectively (FIG. 2c). Based on nonlocal density functional theory (NLDFT), a narrow pore size distribution centering at 2.54 nm was obtained, matching well with the predicted values for the geometry of an AA eclipsed framework (2.64 nm). The Py-Td COF can retain its crystallinity after the treatment of both acid (1 M HCl) and base (3 M NaOH) aqueous solutions for 24 h.

The Py-Py and Etta-Py COFs are also highly crystalline frameworks, as established by the intense reflections in the PXRD patterns. Structure elucidation revealed that these two COFs shared the same symmetry of P2/m with a similar pseudo-quadratic geometry as that of the Py-Td COF. Both samples showed reversible type I isotherms, indicative of the uniform microporous structure of these materials. Fitting these isotherms gave BET surface areas of 958 and 1858 m² g⁻¹ and pore size distributions peaking at 1.50 and 1.30 nm for Py-Py and Etta-Py, respectively. With respect to the Etta-Td COF, the PXRD analysis revealed that it crystallized in the P6m space group with a structure that was in excellent agreement with the proposed AA-stacking mode of a dual-pore Kagome structure. Derived from N₂ sorption isotherms, the calculated BET surface area for this material was 749 m² g⁻¹ with two different pore sizes predominantly distributed at ca. 3.8 and 1.5 nm, assignable to the hexagonal mesopores and triangular micropores, respectively.

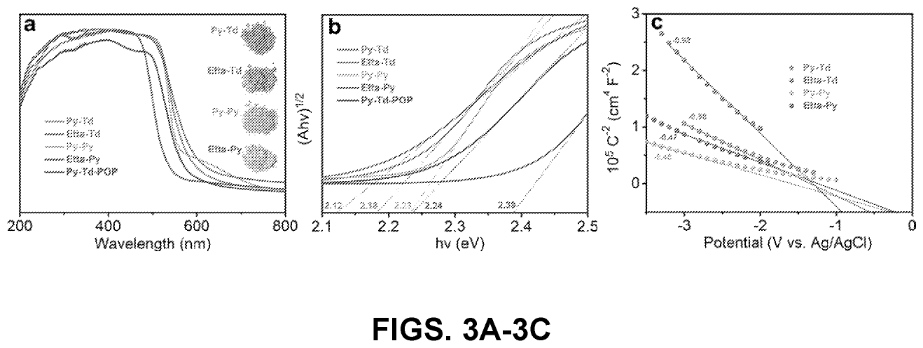

Optical Property Investigation. Given that a material's optical bandgap and energy level alignment have profound consequences on its photoreactivity, these properties of the resulting COFs were investigated through a combination of UV-vis spectroscopy, Mott-Schottky analysis, cyclic voltammetry (CV) measurement, and DFT calculation for cross-validation. In order to examine optical absorption profiles, UV-vis spectroscopy measurements were carried out, showing distinct differences among these COFs. Etta-Py exhibited an absorption maximum at 470 nm, with an absorbance edge at around 563 nm. In comparison, the spectra of the other three COFs are extended to broader regions, with a comparable maximum absorption peak of 514 nm; the absorption onsets are redshifted in the order of Etta-Td>Py-Td>Py-Py (FIG. 3a). The appearance of such differences in the visible-light region is also indicated by colors ranging from yellow to brick red (FIG. 3a, inset), inferring that the electronic band structures around the bandgaps of these materials are significantly different (FIG. 3b). Based on the equation (Ahv)²=α(hv−E_{g}), the optical bandgaps calculated from the plots are 2.39, 2.23, 2.18, and 2.12 eV for Etta-Py, Py-Py, Py-Td, and Etta-Td, respectively, revealing that the incorporation of the Td moieties helps to narrow the bandgap. By contrast, Py-Td-POP, an amorphous analogue of the Py-Td COF, showed an abridged visible region absorption and an increased bandgap to about 2.24 eV, probably as a result of the limited extension of conjugation due to the twisted and disordered structures⁵⁷.

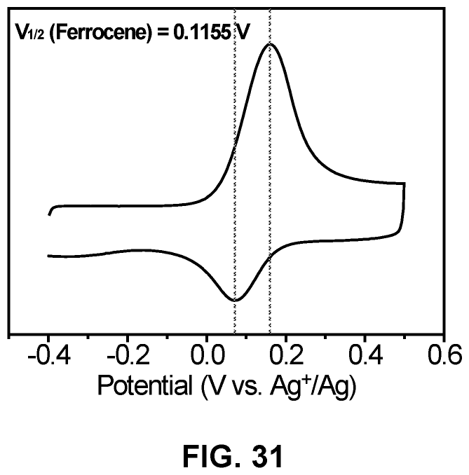

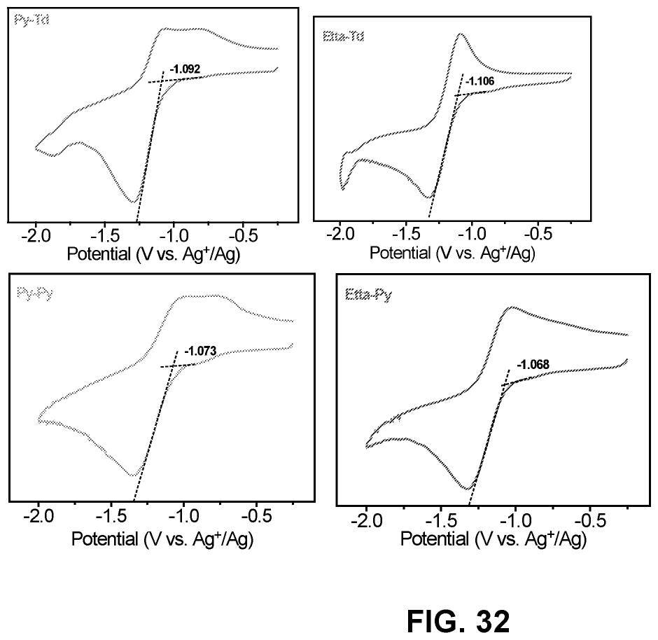

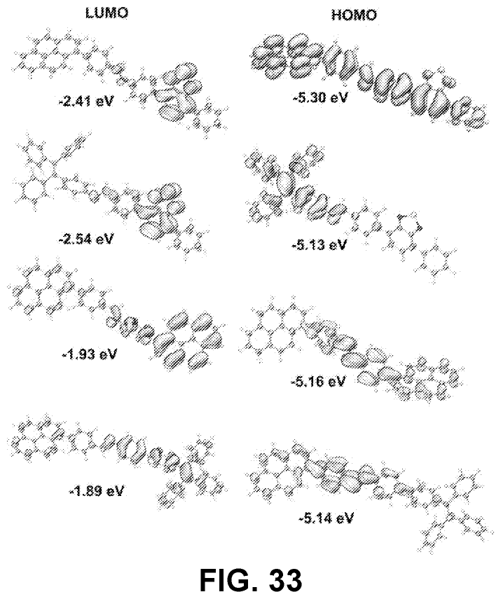

To gain detailed information about the energy level alignment of the COFs, Mott-Schottky electrochemical measurements were performed (FIG. 3c). All the tested materials gave negative slopes of the Mott-Schottky plots, suggestive of a p-type semiconductor behavior. The flat band position values of these COFs calculated via the Mott-Schottky equation at 1/C²=0 are −0.58, −0.92, −0.48, and −0.47 V vs. Ag/AgCl (i.e., −0.58 V, −0.34 V vs. NHE); thus, the corresponding conductor bands are estimated to be −0.34 V, −0.68 V, −0.24 V, and −0.23 V vs. NHE for the Py-Td, Etta-Td, Py-Py, and Etta-Py COFs, respectively. The valence band positions were at 1.84, 1.44, 1.99, and 2.16 V vs. The NHE for Py-Td, Etta-Td, Py-Py, and Etta-Py could thus be derived from the optical bandgap. We further determined the LUMO and HOMO energy levels of these materials, corresponding to their conduction and valence band edges, by using CV measurement that revealed a consistent trend with the Mott-Schottky tests (FIGS. 31 and 32). Further, DFT calculations of the fragmental structures of the COF networks verified that the energy bandgaps and energy alignment follow the same trend as those obtained from the experiments (FIG. 33 and Table 2).

TABLE 2
Summary of the band gaps and energy level alignment of the
synthesized materials.

| | | CB vs. | LUMO vs. | | |
|---|---|---|---|---|---|
| | | NHE | vacuum | | |
| | Eg | (Mott- | (CV | Eg | LUMO |
| Materials | (UV-vis) | Schottky) | measurement) | (DFT) | (DFT) |
| Py-Td | 2.18 eV | −0.34 V | −1.092 eV | 2.89 eV | −2.41 eV |
| Py-Py | 2.23 eV | −0.24 V | −1.073 eV | 3.23 eV | −1.93 eV |
| Etta-Py | 2.39 eV | −0.23 V | −1.068 eV | 3.24 eV | −1.89 eV |
| Etta-Td | 2.12 eV | −0.68 V | −1.106 eV | 2.59 eV | −2.54 eV |
| Py-Td-POP | 2.24 eV | — | — | — | — |

Catalytic Performance Evaluation. Among the developed photocatalytic transformations, molecular oxygen (O₂) involving oxidation reactions have been of great interest, whereby active oxygen species can be generated via the energy or electron transfer pathway from photocatalyst to O₂. Given the oxidizing and electrophilic properties of ¹O₂, this species has been under scrutiny and proven useful in a variety of applications⁵⁸. These materials were thus initially examined as triplet photosensitizers in the ¹O₂ production. To evaluate the efficiency in photogenerated ¹O₂, their performances in the Alder-Ene reaction with α-terpinene as a trapping reagent were tested, as this only proceeds with ¹O₂, therefore facilitating comparisons⁵⁹. The production of ¹O₂ over various materials was monitored by calculating the conversion of α-terpinene into ascaridole (Table 3). To confirm the ¹O₂ generation mechanism, three control experiments were first conducted as follows: (i) in the absence of any photosensitizer; (ii) in the dark and in the presence of photosensitizing material; and (iii) in the dark and with heating with the COFs. Each of these controls showed no ascaridole yield, which is, therefore, indicative of no ¹O₂ generated under the above conditions (Table 3, entries 1-3).

TABLE 3
Catalytic evaluation of α-terpinene into ascaridole over
various photosensitizers. ^{a}

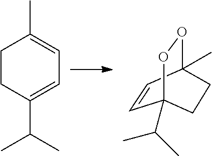

| Entry | Catalyst | Light | Heat | Yield (%) ^{b} |
|---|---|---|---|---|
| 1 | — | + | — | <1 |
| 2 | Py-Td | — | — | <1 |
| 3 | Py-Td | — | + | <1 |
| 4 | Py-Td | + | — | 84 |
| 5 | Py-Td-POP | + | — | 51 |
| 6 | Py-Py | + | — | 24 |
| 7 | Etta-Td | + | — | 52 |
| 8 | Etta-Py | + | — | 29 |
| 9 | thiadiazole | + | — | 11 |
| 10 | tetraphenylethylene | + | — | 4 |
| 11 | tetraphenylpyrene | + | — | 26 |

^{a} Standard reactions were conducted with 1 mmol of α-terpinene, 5
mg of photosensitizer, in 5 mL of CHCl₃ at room temperature under blue LED
irradiation with a power of 10 W/m (total 10 W) for 3 h.
^{b} Yields were determined by ¹H NMR analysis.

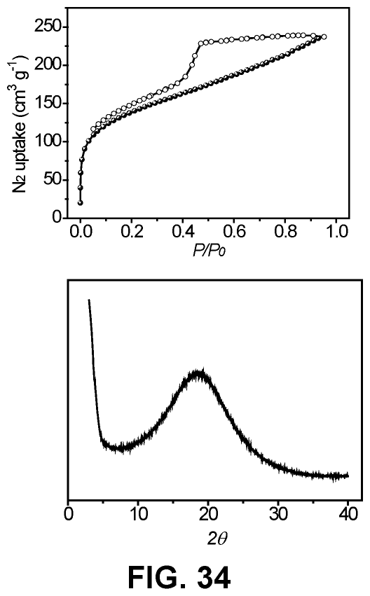

An 84% conversion of α-terpinene to ascaridole was detected after 3 h of irradiation in the presence of Py-Td under the 420 nm LED modules (Table 3, entry 4). Under otherwise identical conditions, its amorphous counterpart, Py-Td-POP (BET: 477 m² g⁻¹, FIG. 34), afforded an ascaridole yield of 51%, which is only around 60% as much as that achieved by using Py-Td (Table 3, entry 5). Given the same chemical composition, their discrepancy in efficiency could have stemmed from their structural differences, wherein the COF skeleton with extended planarity is proven to increase the light absorbability. Moreover, crystalline structures with fewer defects could suppress the recombination of photogenerated electron and hole pairs, thereby highlighting the uniqueness of COFs for photocatalysis. Comparisons of the ¹O₂ generation efficiency of Py-Td with that of other COF materials, including Py-Py, Etta-Py, and Etta-Td, indicate that the efficiency for Py-Td is between 1.6 and 3.5 times greater (Table 3, entries 6-8). Considering that all these COFs are connected by the same imine linkage and paired by two of the three struts, the vast disparities with regard to the photoactive capabilities of these COFs should be more than merely a specific strut.

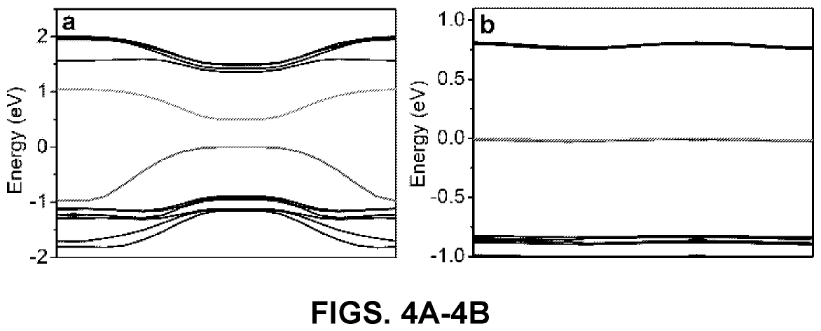

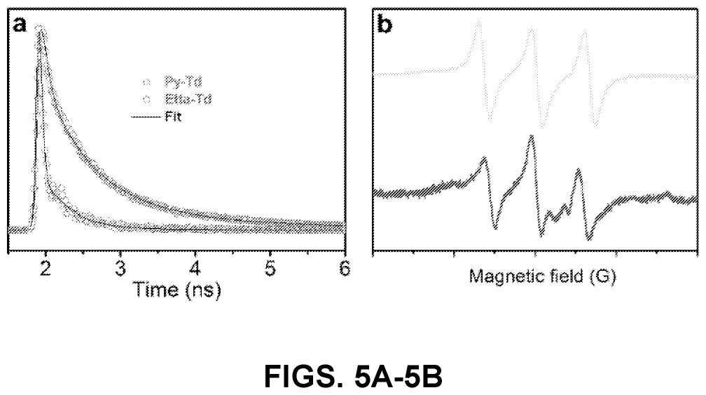

To experimentally prove this, the performance of all the struts involved in the COF syntheses were evaluated, resulting in inferior or comparable activities to the COFs (Table 3, entries 9-11). Taken together, the divergent outcomes of these COFs may not be pinpointed to a single factor change but rather considered a result of a complex interplay of several aspects. An increase in photoabsorption and proper energy level alignment can be used to explain the superior performance of Py-Td in comparison with Etta-Py and Py-Py. However, in the cases of Py-Td and Etta-Td, only a very weak correlation between the catalytic performance and the photoproperties could be established, given that Etta-Td with a broader photoabsorption range and lower LOMO energy level than Py-Td offered an inferior result. Therefore, their activity discrepancy may be ascribed to their differences in charge carrier lifetime, another critical parameter for an efficient photocatalyst. Indeed, computational studies reveal that Etta-Py with P6m symmetry exhibits a nearly flat and overlapped top valence band, resulting in high charge-carrier effective masses⁶⁰. In contrast, the top valence band of Py-Td with C2/m symmetry displays a significant dispersion, giving superior charge-carrier mobility (FIG. 4). These results are in good agreement with the recent theoretical prediction associated with symmetry-electronic property relationships for 2D 7-conjugated materials⁶⁰. To further validate this experimentally, the excited state lifetimes of Py-Td and Etta-Td were evaluated by time-correlated single-photon counting spectros copy in the air at 298 K, verifying that Py-Td showed much longer decay lifetimes than Etta-Td (FIG. 5a).

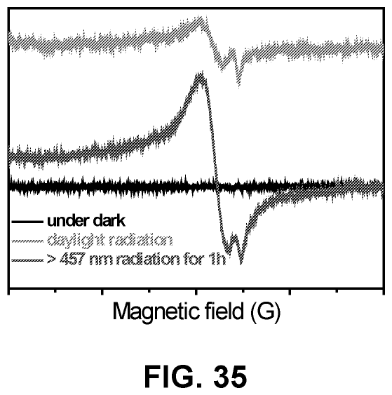

Considering the efficiency in the generation of ¹O₂, this prompted investigations into the potential of these materials in other chemical transformations. Among the developed catalytic reactions that involved triplet photosensitizers, we were interested in the photooxidation of organic sulfides. Given the superior performance, Py-Td was our choice for detailed investigations. The reactivity of Py-Td under visible light was investigated by the photooxidation of thioanisole⁶¹. A full conversion of thioanisole to the desired mono-oxidized product methyl phenyl sulfoxide with a selectivity of 96% was obtained (Table 4, entry 1). Photooxygenation of sulfides involves either an energy-transfer process, whereby ¹O₂ reacts with sulfides to afford the sulfoxides, or an electron transfer process, whereby a superoxide radical (O₂.⁻) acts as an electron mediator in the photoredox cycle. To detect the generated reactive oxygen species by Py-Td, electron paramagnetic resonance (EPR) measurements were carried out. Both EPR signals for ¹O₂ and O₂.⁻ were unequivocally detected when 2,2,6,6-tetra-methyl-1-piperidine (TEMP) and 5,5′-dimethyl-1-pyrroline N-oxide (DMPO), respectively, were used as trapping agents (FIG. 5b and FIG. 35).

TABLE 4
Photocatalytic oxidation of thioanisole using Py-Td.^{a}

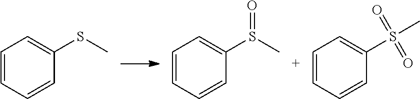

| Entry | Light | Additive | Conv. (%) | Select. (%) ^{b} |
|---|---|---|---|---|
| 1 | Xe lamp | — | 100 | 96 |
| 2 | Xe lamp | benzoquinone | 72 | 96 |
| 3 | Xe lamp | NaN₃ | 93 | 96 |
| 4 | Xe lamp | ethene-1,1,2,2-tetracarbonitrile | 7 | 100 |
| 5 | Xe lamp | 10H-phenothiazine | 8 | 88 |
| 6 | sunlight | — | 100 | 88 |
| 7 ^{c} | Xe lamp | — | 100 | 96 |
| 8 ^{d} | Xe lamp | — | 100 | 93 |

^{a}General reaction conditions: Py-Td (5 mg), thioanisole (1 mmol), acetonitrile (1 mL), Xe lamp, O₂, and RT.
^{b} The selectivity was calculated based on the ratio of methyl phenyl sulfoxide and methyl phenyl sulfone in the products, which were determined by ¹H NMR.
^{c} Reuse.
^{d} Recycled for 5 times.

To obtain more information about the reaction pathway, the role of each reactive oxygen species was investigated. When p-benzoquinone (BQ), an O₂.⁻ scavenger, was introduced to the reaction system, the conversion of thioanisole decreased to 72%, indicative of the role of O₂.⁻. To identify the role of ¹O₂, the singlet oxygen scavenger, sodium azide (NaN₃), was introduced to the reaction system, and the conversion of thioanisole decreased slightly to 93%. Using ethene-1,1,2,2-tetracarbonitrile as a hole scavenger, only 7% of the conversion was measured. A sharply decreased yield (8%) was also observed with 10H-phenothiazine as an electron scavenger (Table 4)^{62,63}. Based on these results, a plausible reaction mechanism for the Py-Td catalyzed the oxidation of sulfides is proposed. The excited Py-Td* experiences an oxidative quenching process by the transfer of electrons to O₂. Through a redox reaction, the sulfides are oxidized by the holes in the valence band of the photosensitizer with the simultaneous regeneration of Py-Td and formation of sulfide radical cation, which is further oxidized by O₂.⁻ or ¹O₂ to afford the desired products.

To expand the applicability of this material, experiments were carried out in batch under natural sunlight irradiation as an alternative to the Xe lamp. Full conversion was achieved within 30 min in the presence of Py-Td. Using sunlight, along with superior performance, we were able to validate the efficiency of the Py-Td COF, thus implying its potential for low-environmental-impact transformations.

To explore the versatility of the Py-Td catalyst, a number of sulfide derivatives were evaluated. Various aryl sulfide substrates bearing chlorine, fluorine, methoxy, and methyl functionalities could be selectively oxidized with moderate to high conversions (Table 5). The applicability of Py-Td for sulfur mustard simulant oxidation was investigated. As one of the most broadly used and notorious chemical weapons, sulfur mustard can cause grievous skin blisters and irritation to the respiratory system or even death at high doses⁶⁴. The selective oxidative detoxification of sulfur mustard to sulfoxide is a promising route. In this context, the capability of Py-Td in the oxidation of a sulfur mustard simulant 2-chloroethyl ethyl sulfide (CEES) was evaluated, affording full conversion within 1 h and thereby exhibiting great potential for rapidly and highly selectively detoxifying sulfur mustard (Table 5, entry 6).

TABLE 5
Photocatalytic oxidation of sulfides over the Py-Td COF.^{a}

| Entry | Substrate | Product | Conv. (%) ^{b} | Select. (%) ^{b} |
|---|---|---|---|---|
| 1 | 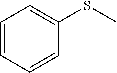 | 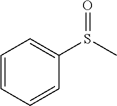 | 100 | 96 |
| 2 | 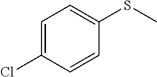 | 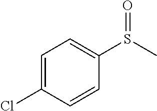 | 59 | 94 |
| 3 | 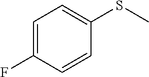 | 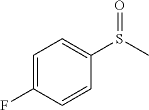 | 100 | 93 |
| 4 | 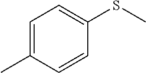 | 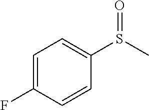 | 48 | 95 |
| 5 | 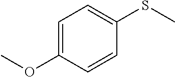 | 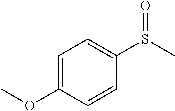 | 45 | 96 |
| 6 | 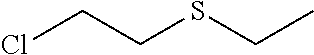 | 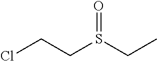 | 100 | 100 |

^{a}General reaction conditions: Py-Td (5 mg), sulfide compound (1 mmol), acetonitrile (1 mL), Xe lamp (λ > 420 nm), O₂, and RT.
^{b} The selectivity was calculated based on the ratio of methyl phenyl sulfoxide and methyl phenyl sulfone in the products, which were determined by ¹H NMR.

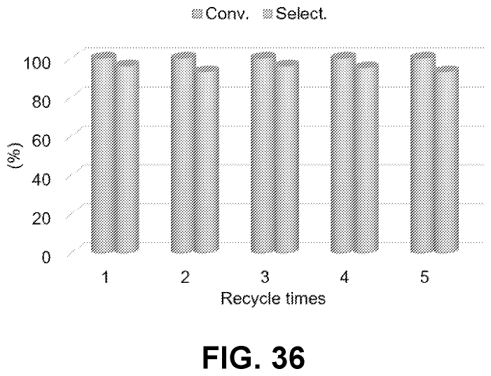

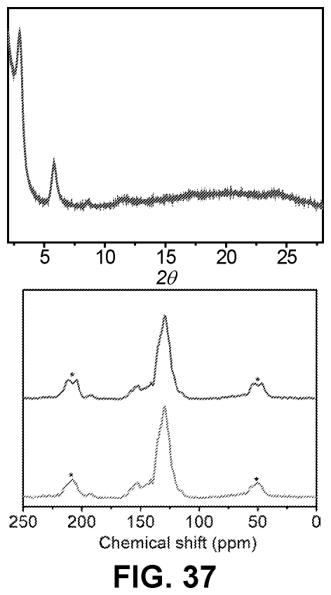

Catalytic Performance Evaluation in a Continuous Flow Reactor. A continuous flow experiment was conducted using Py-Td with the experimental setup described in FIG. 6. A full conversion of thioanisole after a single pass of the 1 mL solution of thioanisole (50 μL in 20 mL of acetonitrile) was observed, prompting further investigations to determine the long-term stability of Py-Td. To examine this, a continuous stream of the thioanisole solution was allowed to pass through the column, taking measurements at 1 h intervals. No decrease in the conversion rate was observed after 50 measurements (FIG. 6). To further validate the stability of Py-Td under reaction conditions, its recyclability in the photooxidation of thioanisole was evaluated by monitoring the performance over five consecutive runs, showing that both conversion and selectivity were maintained, indicating its robust structure, which was further evidenced by its retained PXRD pattern (FIGS. 36 and 37). The Py-Td COF is also chemically stable, as supported by the negligible difference in the solid-state ¹³C NMR spectra between the fresh synthesized Py-Td and the one that has been used for 5 times (FIG. 37).

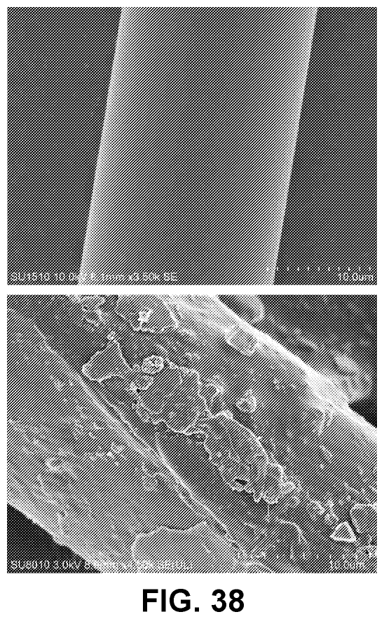

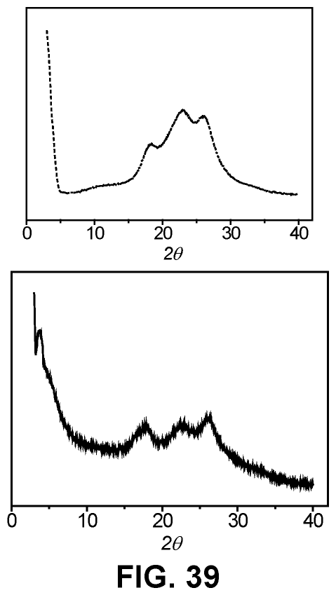

Incorporation of COFs into Fabrics and Textiles. Py-Td was integrated with protective fabrics to combine the self-detoxifying properties of the COF with the air permeation of textiles. To target this, nylon-66 fabric was chosen for its chemical resistance and mechanical strength. To increase the affinity between the substrate and the COF for potential application in process-intensive conditions, the fabric was first modified with poly-dopamine, followed by a bottom-up synthetic pathway, by submerging it hem into the system for COF synthesis. The SEM images indicate the successful deposition of the Py-Td COF crystals on it (FIGS. 38 and 39). The composite exhibited excellent performance regarding the oxidation of CEES with full conversion within 1 h (0.5 μL of CEES in 1 mL of acetonitrile).

TABLE 6
Atomistic coordinates for the AA-stacking mode of Py-Td optimized
using Forcite method (space group CM, a = 44.3760 Å;
b = 48.9005; c = 3.7523 Å, α = γ = 90° and β = 106.4589°).

| Atom | x/a | y/b | z/c |
|---|---|---|---|
| C1 | 0.81223 | 0.8387 | 0.42019 |
| C2 | 0.78907 | 0.81936 | 0.40266 |
| H3 | 0.65691 | 0.38106 | 0.74714 |
| H4 | 0.5878 | 0.54886 | 0.86864 |
| H5 | 0.80545 | 0.85833 | 0.29334 |
| H6 | 0.76555 | 0.82467 | 0.25746 |
| C7 | 0.52743 | 0.44193 | 0.47277 |
| C8 | 0.52676 | 0.47091 | 0.45155 |
| C9 | 0.55055 | 0.4858 | 0.36909 |
| C10 | 0.05544 | 0.92525 | 0.47991 |
| C11 | 0.07828 | 0.88373 | 0.31466 |
| C12 | 0.10761 | 0.89169 | 0.53306 |
| C13 | 0.86634 | 0.87513 | 0.43023 |
| H14 | 0.56917 | 0.5243 | 0.29503 |
| C15 | 0.61066 | 0.41643 | 0.72546 |
| C16 | 0.58482 | 0.4328 | 0.70396 |
| C17 | 0.79634 | 0.20663 | 0.56145 |
| C18 | 0.8505 | 0.19319 | 0.76375 |
| N19 | 0.86824 | 0.14891 | 0.61194 |
| H20 | 0.92611 | 0.13509 | 0.83597 |
| C21 | 0.94916 | 0.09961 | 0.71315 |
| C22 | 0.22605 | 0.769 | 0.4604 |
| C23 | 0.25544 | 0.77562 | 0.4242 |
| C24 | 0.77808 | 0.74469 | 0.45549 |
| C25 | 0.15689 | 0.16906 | 0.40004 |
| C26 | 0.67142 | 0.71397 | 0.23079 |
| H27 | 0.33366 | 0.73214 | 0.87866 |
| H28 | 0.53034 | 0.60643 | 0.11716 |
| H29 | 0.62525 | 0.69794 | 0.06265 |
| H30 | 0.63298 | 0.57719 | 0.89982 |
| N31 | 0.26082 | 0.79643 | 0.36694 |
| N32 | 0.30017 | 0.76107 | 0.41858 |
| C33 | 0.188 | 0.83588 | 0.5926 |
| C34 | 0.21044 | 0.81586 | 0.60746 |
| H35 | 0.34469 | 0.38198 | 0.24709 |
| H36 | 0.41444 | 0.54851 | 0.13471 |
| H37 | 0.19531 | 0.85488 | 0.73485 |
| H38 | 0.23409 | 0.81995 | 0.76339 |
| C39 | 0.47464 | 0.44196 | 0.53254 |
| C40 | 0.47541 | 0.47092 | 0.55522 |
| C41 | 0.45164 | 0.48581 | 0.63798 |
| C42 | 0.94652 | 0.92536 | 0.52287 |
| C43 | 0.92324 | 0.88395 | 0.68495 |
| C44 | 0.89403 | 0.89214 | 0.466 |
| C45 | 0.13505 | 0.87437 | 0.56722 |
| H46 | 0.43299 | 0.52428 | 0.71152 |
| C47 | 0.39126 | 0.41691 | 0.27466 |
| C48 | 0.41725 | 0.43311 | 0.29806 |
| C49 | 0.20231 | 0.20944 | 0.43186 |
| C50 | 0.14899 | 0.19397 | 0.2165 |
| N51 | 0.13259 | 0.14975 | 0.38627 |
| H52 | 0.07517 | 0.13528 | 0.16273 |
| C53 | 0.05255 | 0.09967 | 0.28822 |
| C54 | 0.77204 | 0.77214 | 0.52658 |
| C55 | 0.74253 | 0.77823 | 0.56161 |
| C56 | 0.22047 | 0.74156 | 0.53068 |
| C57 | 0.84333 | 0.16761 | 0.59688 |
| C58 | 0.32733 | 0.71255 | 0.7463 |
| H59 | 0.66463 | 0.73289 | 0.08224 |
| H60 | 0.47128 | 0.60651 | 0.88478 |
| H61 | 0.37426 | 0.69824 | 0.9053 |
| H62 | 0.36903 | 0.57652 | 0.10001 |
| N63 | 0.73297 | 0.80296 | 0.6363 |
| S64 | 0.69631 | 0.80211 | 0.66835 |
| N65 | 0.69423 | 0.76808 | 0.58379 |
| C66 | 0.00109 | 0.01457 | 0.50362 |
| C67 | 0.50101 | 0.57188 | 0.50234 |
| H68 | 0.50096 | 0.594 | 0.50163 |

TABLE 7
Atomistic coordinates for the AA-stacking mode of Py-Py optimized
using Forcite method (space group P2/m, a = 26.2954 Å;
b = 24.0417 Å; c = 4.1420 Å, α = γ = 90°, and β = 79.4925°).

| Atom | x/a | y/b | z/c |
|---|---|---|---|
| C1 | 0.3983 | 0.55064 | 0.3836 |
| C2 | 0.44925 | 0.55093 | 0.43809 |
| C3 | 0.47515 | 0.60047 | 0.47271 |
| C4 | 0.36584 | 0.60107 | 0.39881 |
| C5 | 0.37964 | 0.64686 | 0.19139 |
| C6 | 0.34784 | 0.69315 | 0.20965 |
| C7 | 0.30104 | 0.69411 | 0.42858 |
| C8 | 0.28643 | 0.64754 | 0.62981 |
| C9 | 0.31866 | 0.60186 | 0.61593 |
| C10 | −0.1046 | 0.05075 | 0.42475 |
| C11 | −0.05261 | 0.05084 | 0.4591 |
| C12 | −0.02539 | 0.1 | 0.48227 |
| C13 | −0.13532 | 0.10205 | 0.41223 |
| C14 | −0.18364 | 0.10717 | 0.61473 |
| C15 | −0.21325 | 0.15452 | 0.59854 |
| C16 | −0.19501 | 0.19763 | 0.37921 |
| C17 | −0.14721 | 0.19225 | 0.17464 |
| C18 | −0.11812 | 0.14472 | 0.18813 |
| C19 | −0.22485 | 0.2483 | 0.35627 |
| N20 | −0.26947 | 0.25757 | 0.56579 |
| H21 | 0.45767 | 0.64035 | 0.45924 |
| H22 | 0.41496 | 0.64688 | 0.01551 |
| H23 | 0.35937 | 0.72819 | 0.04892 |
| H24 | 0.25058 | 0.64559 | 0.79981 |
| H25 | 0.30684 | 0.56699 | 0.77776 |
| H26 | −0.04289 | 0.14006 | 0.47768 |
| H27 | −0.19814 | 0.07481 | 0.7893 |
| H28 | −0.25009 | 0.1575 | 0.7592 |
| H29 | −0.13255 | 0.22463 | 0.00056 |
| H30 | −0.08191 | 0.14148 | 0.02434 |
| H31 | −0.20985 | 0.27796 | 0.16679 |
| C32 | 0.4747 | 0.5 | 0.46664 |
| C33 | 0.37465 | 0.5 | 0.34729 |
| H34 | 0.33585 | 0.5 | 0.3028 |
| H35 | 0.16855 | 0 | 0.62856 |
| C36 | 0.12926 | 0 | 0.59422 |
| C37 | 0.02716 | 0 | 0.52255 |

TABLE 8
Atomistic coordinates for the AA-stacking mode of Etta-Py
optimized using Forcite method (space group P2/m, a = 5.650 Å;
b = 22.9791; c = 20.3109 Å, α = γ = 90°, and β = 79.8415°).

| Atom | x/a | y/b | z/c |
|---|---|---|---|
| N1 | −1.3496 | −0.28436 | 1.32293 |
| C2 | −0.78784 | 0.05361 | 0.86572 |
| C3 | −0.81868 | 0.0569 | 0.9389 |
| C4 | −0.97229 | 0.10696 | 0.96327 |
| H5 | −1.14959 | 0.10625 | 0.94458 |
| C6 | −0.71871 | 0.1067 | 0.82618 |
| C7 | −0.51894 | 0.14124 | 0.83702 |
| H8 | −0.41177 | 0.12904 | 0.87325 |
| C9 | −0.45511 | 0.19185 | 0.8011 |
| H10 | −0.30083 | 0.21788 | 0.81082 |
| C11 | −0.58987 | 0.20904 | 0.7536 |
| C12 | −0.78873 | 0.17416 | 0.74203 |
| H13 | −0.89605 | 0.18639 | 0.70565 |
| C14 | −0.85175 | 0.12315 | 0.77792 |
| H15 | −1.00659 | 0.09701 | 0.76881 |
| C16 | −1.45954 | −0.44412 | 1.42891 |
| C17 | −1.39491 | −0.33806 | 1.35881 |
| C18 | −1.48005 | −0.2637 | 1.28214 |
| C19 | −0.37429 | −0.42778 | 0.61141 |
| H20 | −0.21417 | −0.45385 | 0.61497 |
| C21 | −0.40737 | −0.37593 | 0.64674 |
| H22 | −0.27529 | −0.36629 | 0.67756 |
| C23 | −0.76666 | −0.35348 | 0.59947 |
| H24 | −0.91827 | −0.32475 | 0.59386 |
| C25 | −0.73607 | −0.40614 | 0.56525 |
| H26 | −0.86498 | −0.41741 | 0.53411 |
| H27 | −0.6312 | 0.06295 | 0.9512 |
| H28 | −0.87542 | 0.14851 | 0.94735 |
| H29 | −1.64081 | −0.28662 | 1.27199 |
| C30 | −0.50974 | −0.5 | 0.53409 |
| C31 | −0.9217 | 0 | 0.97072 |
| C32 | −0.78316 | 0 | 0.83375 |
| H33 | −0.7495 | 0 | 0.78149 |

TABLE 9
Atomistic coordinates for the AA-stacking mode of Etta-Td
optimized using Forcite method (space group P6,
a = b = 54.0202 Å; c = 4.6450 Å, α = β = 90° and γ = 120°).

| Atom | x/a | y/b | z/c |
|---|---|---|---|
| C1 | 0.4865 | 0.48778 | 0.51501 |
| C2 | 0.45987 | 0.48838 | 0.50956 |
| C3 | 0.43723 | 0.46828 | 0.3547 |
| C4 | 0.41206 | 0.4676 | 0.35308 |
| C5 | 0.40893 | 0.48727 | 0.50408 |
| C6 | 0.43113 | 0.50745 | 0.65558 |
| C7 | 0.45599 | 0.50758 | 0.66319 |
| C8 | 0.4828 | 0.45948 | 0.51029 |
| C9 | 0.46338 | 0.43882 | 0.68819 |
| C10 | 0.45937 | 0.41223 | 0.68128 |
| C11 | 0.47523 | 0.40599 | 0.50166 |
| C12 | 0.49413 | 0.42619 | 0.31854 |
| C13 | 0.49724 | 0.45241 | 0.31924 |
| C14 | 0.35879 | 0.4647 | 0.52429 |
| C15 | 0.33369 | 0.46662 | 0.51536 |
| C16 | 0.31102 | 0.44886 | 0.68083 |
| C17 | 0.28733 | 0.45102 | 0.6802 |
| C18 | 0.28562 | 0.47045 | 0.50687 |
| C19 | 0.3083 | 0.48793 | 0.33784 |
| C20 | 0.33222 | 0.48621 | 0.34405 |
| C21 | 0.26065 | 0.47314 | 0.50747 |
| C22 | 0.49334 | 0.37482 | 0.53233 |
| C23 | 0.48917 | 0.34687 | 0.52925 |
| C24 | 0.50615 | 0.34074 | 0.6933 |
| C25 | 0.50247 | 0.31428 | 0.6923 |
| C26 | 0.48213 | 0.29363 | 0.52177 |
| C27 | 0.46549 | 0.30005 | 0.35317 |
| C28 | 0.46873 | 0.32635 | 0.35985 |
| C29 | 0.47886 | 0.26573 | 0.51624 |
| C30 | 0.50213 | 0.26249 | 0.51216 |
| C31 | 0.45296 | 0.24178 | 0.51539 |
| C32 | 0.49931 | 0.23625 | 0.50835 |
| C33 | 0.23402 | 0.4502 | 0.50969 |
| H34 | 0.47237 | 0.52348 | 0.78049 |
| H35 | 0.43877 | 0.45272 | 0.23706 |
| H36 | 0.3952 | 0.45202 | 0.23054 |
| H37 | 0.42905 | 0.52292 | 0.77157 |
| H38 | 0.45117 | 0.44326 | 0.83075 |
| H39 | 0.44444 | 0.39669 | 0.82134 |
| H40 | 0.50618 | 0.42156 | 0.17367 |
| H41 | 0.51177 | 0.46775 | 0.18096 |
| H42 | 0.35733 | 0.44522 | 0.57498 |
| H43 | 0.31194 | 0.43383 | 0.8168 |
| H44 | 0.27062 | 0.43788 | 0.82002 |
| H45 | 0.30749 | 0.50285 | 0.19934 |
| H46 | 0.3494 | 0.49989 | 0.21182 |
| H47 | 0.51362 | 0.39195 | 0.57718 |
| H48 | 0.52196 | 0.35633 | 0.82608 |
| H49 | 0.51541 | 0.30992 | 0.82678 |
| H50 | 0.45031 | 0.28493 | 0.21188 |
| H51 | 0.45578 | 0.33085 | 0.22713 |
| N52 | 0.38367 | 0.48757 | 0.49934 |
| N53 | 0.47183 | 0.37906 | 0.50524 |
| N54 | 0.57125 | 0.75898 | 0.52241 |
| S55 | 0.59794 | 0.79156 | 0.51501 |
| N56 | 0.57609 | 0.80401 | 0.50531 |
| H57 | 0.52257 | 0.28025 | 0.50964 |
| H58 | 0.51767 | 0.23459 | 0.50959 |

From the foregoing, it will be seen that aspects herein are well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings is to be interpreted as illustrative and not in a limiting sense.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

### REFERENCES

1. Asahi, R., Morikawa, T., Ohwaki, T., Aoki, K., and Taga, A. Y. (2001). Visible-light photocatalysis in nitrogen-doped titanium oxides. Science 293, 269-271.
2. Lang, X., Chen, X., and Zhao, J. (2014). Heterogeneous visible light photocatalysis for selective organic transformations. Chem. Soc. Rev. 43, 473-486.
3. Yoon, T. P., Ischay, M. A., and Du, J. (2010). Visible light photocatalysis as a greener approach to photochemical synthesis. Nat. Chem. 2, 527-532.
4. Wang, X., Zhang, L., Chen, Z., Hu, J., Li, S., Wang, Z., Liu, J., and Wang, X. (2014). Semiconductor heterojunction photocatalysts: design, construction, and photocatalytic performances. Chem. Soc. Rev. 43, 5234-5244.
5. Romero, N. A., and Nicewicz, D. A. (2016). Organic photoredox catalysis. Chem. Rev. 116, 10075-10166.
6. McAtee, R. C., McClain, E. J., and Stephenson, C. R. J. (2019). Illuminating photoredox catalysis. Trends in Chemistry 1, 111-125.
7. Romero, N. A., and Nicewicz, D. A. (2016). Organic photoredox catalysis. 116, 10075-10166.
8. Liang, H.-P., Chen, Q., and Han, B.-H. (2018). Cationic polycarbazole networks as visible-light heterogeneous photocatalysts for oxidative organic transformations. ACS Catal. 8, 5313-5322.
9. Zhang, G., Lan, Z.-A., and Wang, X. (2016). Conjugated polymers: catalysts for photocatalytic hydrogen evolution. Angew. Chem. Int. Ed. 55, 15712-15727.
10. Ma, L., Liu, Y., Liu, Y., Jiang, S., Li, P., Hao, Y., Shao, P., Yin, A., Feng, X., and Wang, B. (2019). Ferrocene-linkage-facilitated charge separation in conjugated microporous polymers. Angew. Chem. Int. Ed. 58, 4221-4226.
11. Zhang, K., Kopetzki. D., Seeberger, P. H., Antonietti, M., and Vilela, F. (2013). Surface area control and photocatalytic activity of conjugated microporous poly(benzothiadiazole) networks. Angew. Chem. Int. Ed. 52, 1432-1436.
12. Wu, W., Xu, S., Qi, G., Zhu, H., Hu, F., Liu, Z., Zhang, D., and Liu, B. (2019). A cross-linked conjugated polymer photosensitizer enables efficient sunlight-induced photooxidation. Angew. Chem. Int. Ed. 58, 3062-3066.
13. Li, L., Cai, Z., Wu, W.-Y., Zhang, N., Chen, L. X., and Yu, L. (2016). Rational design of porous conjugated polymers and roles of residual palladium for photocatalytic hydrogen production. J. Am. Chem. Soc. 138, 7681-7686.
14. Sprick, R. S., Jiang, J.-X., Bonillo, B., Ren, S., Ratvijitvech, T., Guiglion, P., Zwijnenburg, M. A., Adams, D. J., and Cooper, A. I. (2015). Tunable organic photocatalysts for visible-light-driven hydrogen evolution. J. Am. Chem. Soc. 137, 3265-3270.
15. Zhang, T., and Lin, W. (2014). Metal-organic frameworks for artificial photosynthesis and photocatalysis. Chem. Soc. Rev. 43, 5982-5993.
16. Li, R., Byun, J., Huang, W., Ayed, C., Wang, L., and Zhang, K. A. I. (2018). Poly(benzothiadiazoles) and their derivatives as heterogeneous photocatalysts for visible-light-driven chemical transformations. ACS Catal. 8, 4735-4750
17. Yu, X., Yang, Z., Qiu, B., Guo, S., Yang, P., Yu, B., Zhang, H., Zhao, Y., Yang, X., Han, B., and Liu, Z. (2019). Eosin Y-functionalized conjugated organic polymers for visible light-driven CO₂ reduction with H₂O to CO with high efficiency. Angew. Chem. Int. Ed. 58, 632-636.
18. Sun, D., Jang, S., Yim, S.-J., Ye, L., and Kim, D.-P. (2018). Metal doped core-shell metal-organic frameworks@covalent organic frameworks (MOFs@COFs) hybrids as a novel photocatalytic platform. Adv. Funct. Mater. 28, 1707110.
19. Xiao, J.-D., and Jiang, H.-L. (2019). Metal-organic frameworks for photocatalysis and photothermal catalysis. Acc. Chem. Res. 52, 356-366.
20. Côté, A. P., Benin, A. I., Ockwig, N. W., O'Keeffe, M., Matzger, A. J., and Yaghi, O. M. (2005). Porous, crystalline, covalent organic frameworks. Science 310, 1166-1170
21. Feng, X., Ding, X., and Jiang, D. (2012). Covalent organic frameworks. Chem. Soc. Rev. 41, 6010-6022
22. Ding, S.-Y., and Wang, W. (2013). Covalent organic frameworks (COFs): from design to applications. Chem. Soc. Rev. 42, 548-568
23. Song, Y., Sun, Q., Aguila, B., and Ma, S. (2019). Opportunities of covalent organic frameworks for advanced applications. Adv. Sci. 8, 1801410.
24. Bisbey, R. P., and Dichtel, W. R. (2017). Covalent organic frameworks as a platform for multidimensional polymerization. ACS. Cent. Sci. 3, 533-543
25. Zhou, T.-Y., Xu, S.-Q., Wen, Q., Pang, Z.-F., and Zhao, X. (2014). One-step construction of two different kinds of pores in a 2D covalent organic framework. J. Am. Chem. Soc. 136, 15885-15888
26. Kandambeth, S., Dey, K., and Banerjee, R. (2019). Covalent organic frameworks: chemistry beyond the structure. J. Am. Chem. Soc. 141, 1907-1822
27. Lohse, M. S., and Bein, T. (2018). Covalent organic frameworks: structures, synthesis, and applications. Adv. Funct. Mater. 28, 170553
28. Jin, Y., Hu, Y., and Zhang, W. (2017). Tessellated multiparous two-dimensional covalent organic frameworks. Nat. Rev. Chem. 1, s41570-017
29. Sun, Q., Aguila, B., Perman, J. A., Nguyen, N., and Ma, S. (2016). Flexibility matters: cooperative active sites in covalent organic framework and threaded ionic polymer. J. Am. Chem. Soc. 138, 15790-15796.
30. Wang, X., Han, X., Zhang, J., Wu, X., Liu, Y., and Cui, Y. (2016). Homochiral 2D porous covalent organic frameworks for heterogeneous asymmetric catalysis J. Am. Chem. Soc. 138, 12332-12335
31. Lu, S., Hu, Y., Wan, S., McCaffrey, R., Jin, Y., Gu, H., and Zhang, W. (2017). Synthesis of ultrafine and highly dispersed metal nanoparticles confined in a thioether-containing covalent organic framework and their catalytic applications. J. Am. Chem. Soc. 139, 17082-17088
32. Liu, H., Chu, J., Yin, Z., Cai, X., Zhuang, L., and Deng, H. (2018). Covalent organic frameworks linked by amine bonding for concerted electrochemical reduction of CO₂. Chem 4, 1696-1709
33. Sun, Q., Aguila, B., Perman, J., Earl, L., Abney, C., Cheng, Y., Wei, H., Nguyen, N., Wojtas, L., and Ma, S. (2017). Postsynthetically modified covalent organic frameworks for efficient and effective mercury removal. J. Am. Chem. Soc. 139, 2786-2793.
34. Huang, N., Zhai, L., Xu, H., and Jiang, D. (2017). Stable covalent organic frameworks for exceptional mercury removal from aqueous solutions. J. Am. Chem. Soc. 139, 2428-2434
35. Li, Z., Li, H., Guan, X., Tang, J., Yusran, Y., Li, Z., Xue, M., Fang, Q., Yan, Y., Valtchev, V., and Qiu, S. (2017). Three-dimensional ionic covalent organic frameworks for rapid, reversible, and selective ion exchange. J. Am. Chem. Soc. 139, 17771-17774
36. Kandambeth, S., Venkatesh, V., Shinde, D. B., Kumari, S., Halder, A., Verma, S., and Banerjee, R. (2015). Self-templated chemically stable hollow spherical covalent organic framework. Nat. Commun. 6, 6786
37. Peng, Y., Huang, Y., Zhu, Y., Chen, B., Wang, L., Lai, Z., Zhang, Z., Zhao, M., Tan, C., Yang, N., Shao, F., Han, Y., and Zhang, H. (2017). Ultrathin two-dimensional covalent organic framework nanosheets: preparation and application in highly sensitive and selective DNA detection. J. Am. Chem. Soc. 139, 8698-8704.
38. Sun, Q., Fu, C.-W., Aguila, B., Perman, J. A., Wang, S., Huang, H.-Y., Xiao, F.-S., and Ma, S. (2018). Pore environment control and enhanced performance of enzymes infiltrated in covalent organic frameworks. J. Am. Chem. Soc. 140, 984-992
39. Ma, H., Liu, B., Li, B., Zhang, L., Li, Y.-G., Tan, H.-Q., Zang, H.-Y., and Zhu, G. (2016). Cationic covalent organic frameworks: a simple platform of anionic exchange for porosity tuning and proton conduction. J. Am. Chem. Soc. 138, 5897-5903
40. Zeng, Y., Zou, R., and Zhao, Y. Covalent organic frameworks for CO₂ capture. (2016). Adv. Mater. 28, 2855-2873
41. Wang, S., Wang, Q., Shao, P., Han, Y., Gao, X., Ma, L., Yuan, S., Ma, X., Zhou, J., Feng, X., and Wang, B. (2017). Exfoliation of covalent organic frameworks into few-layer redox-active nanosheets as cathode materials for lithium-ion batteries. J. Am. Chem. Soc. 139, 4258-4261.
42. Chen, R., Shi, J.-L., Ma, Y., Lin, G., Lang, X., and Wang, C. (2019). Designed synthesis of a 2D porphyrin-based sp² carbon conjugated covalent organic framework for heterogeneous photocatalysis. Angew. Chem. Int. Ed. 58, 6430-6434
43. Lv, J., Tan, Y.-X., Xie, J., Yang, R., Yu, M., Sun, S., Li, M.-D., Yuan, D., and Wang, Y. (2018). Direct solar-to-electrochemical energy storage in a functionalized covalent organic framework. Angew. Chem. Int. Ed. 57, 12716-12720
44. Yang, S., Hu, W., Zhang, X., He, P., Pattengale, B., Liu, C., Cendejas, M., Hermans, I., Zhang, X., Zhang, J., and Huang, J. (2018). 2D covalent organic Frameworks as intrinsic photocatalysts for visible light-driven CO₂ reduction. J. Am. Chem. Soc. 140, 14614-14618.
45. Pachfule, P., Acharjya, A., Roeser, J., Langenhahn, T., Schwarze, M., Schomäcker, R., Thomas, A., and Schmidt, J. (2018). Diacetylene functionalized covalent organic framework (COF) for photocatalytic hydrogen generation. J. Am. Chem. Soc. 140, 1423-1427.
46. Keller, N., Bessinger, D., Reuter, S., Calik, M., Ascherl, L., Hanusch, F. C., Auras, F., and Bein, T. (2017). Oligothiophene-bridged conjugated covalent organic frameworks. J. Am. Chem. Soc. 139, 8194-8199.
47. Vyas, V. S., Haase, F., Stegbauer, L., Savasci, G., Podjaski, F., Ochsenfeld, C., and Lotsch, B. V. (2015). A tunable azine covalent organic framework platform for visible light-induced hydrogen generation. Nat. Commun. 6, 8508
48. Wei, P.-F., Qi, M.-Z., Wang, Z.-P., Ding, S.-Y., Yu, W., Liu, Q., Wang, L.-K., Wang, H.-Z., An, W.-K., and Wang, W. (2018). Benzoxazole-linked ultrastable covalent organic frameworks for photocatalysis. J. Am. Chem. Soc. 140, 4623-4631.
49. Li, Z., Zhi, Y., Shao, P., Xia, H., Li, G., Feng, X., Chen, X., Shi, Z., and Liu, X. (2019). Covalent organic framework as an efficient, metal-free, heterogeneous photocatalyst for organic transformations under visible light. Appl. Catal. B. Envir. 245, 334-342.
50. Zhao, Y., Liu, H., Wu, C., Zhang, Z., Pan, Q., Hu, F., Wang, R., Li, P., Huang, X., and Li, Z. (2019). Fully conjugated two-dimensional sp²-carbon covalent organic frameworks as artificial photosystem I with high efficiency. Angew. Chem. Int. Ed. 58, 5376-5381
51. He, J., Yin, B., Niu, H., and Cai, Y. (2018). Targeted synthesis of visible-light-driven covalent organic framework photocatalyst via molecular design and precise construction. Appl. Catal. B. Envir. 239, 147-153
52. Wu, C., Liu, Y., Liu, H., Duan, C., Pan, Q., Zhu, J., Hu, F., Ma, X., Jiu, T., Li, Z., and Zhao, Y. (2018). Highly conjugated three-dimensional covalent organic frameworks based on spirobifluorene for perovskite solar cell enhancement. J. Am. Chem. Soc. 140, 10016-10024.
53. Bhadra, M., Kandambeth, S., Sahoo, M. K., Addicoat, M., Balaraman, E., and Banerjee, R. (2019). Triazine functionalized porous covalent organic framework for photo-organocatalytic E-Z isomerization of olefins J. Am. Chem. Soc. 141, 6152-6156
54. Jin, E., Lan, Z., Jiang, Q., Geng, K., Li, G., Wang, X., and Jiang, D. (2019). 2D sp² carbon-conjugated covalent organic frameworks for photocatalytic hydrogen production from water. Chem 5, 1632-1647.
55. Li, X., Gao, Q., Aneesh, J., Xu, H.-S., Chen, Z., Tang, W., Liu, C., Shi, X., Adarsh, K. V., Lu, Y., and Loh, K. P. (2018). Molecular engineering of bandgaps in covalent organic frameworks. Chem. Mater. 30, 5743-5749.
56. Wang, X., Chen, L., Chong, S. Y., Little, M. A., Wu, Y., Zhu, W.-H., Clowes, R., Yan, Y., Zwijnenburg, M. A., Sprick, R. S., and Cooper, A. I. (2018). Sulfone-containing covalent organic frameworks for photocatalytic hydrogen evolution from water. Nat. Chem. 10, 1180-1189.
57. Sprick, R. S., Bonillo, B., Clowes, R., Guiglion, P., Brownbill, N. J., Slater, B. J., Blanc, F., Zwijnenburg, M. A., Adams, D. J., and Cooper, A. I. (2016). Visible-light-driven hydrogen evolution using planarized conjugated polymer photocatalysts. Angew. Chem. Int. Ed. 55, 1792-1796.
58. DeRosa, M. C., and Crutchley, R. J. (2002). Photosensitized singlet oxygen and its applications. Coord. Chem. Rev. 233-234, 351-371.
59. Tobin, J. M., McCabe, T. J. D., Prentice, A. W., Holzer, S., Lloyd, G. O., Paterson, M. J., Arrighi, V., Cormack, P. A. G., and Vilela, F. (2017). Polymer-supported photosensitizers for oxidative organic transformations in flow and under visible light irradiation. ACS Catal. 7, 4602-4612.
60. Thomas, S., Li, H., Zhong, C., Matsumoto, M., Dichtel, W. R., and Bredas, J.-L. (2019). Electronic structure of two-dimensional π-conjugated covalent organic frameworks. Chem. Mater. 31, 3051-3065
61. Wang, Z. J., Ghasimi, S., Landfester, K., and Zhang, K. A. I. (2014). Highly porous conjugated polymers for selective oxidation of organic sulfides under visible light. Chem. Commun. 50, 8177-8180.
62. Battula, V. R., Singh, H., Kumar, S., Bala, I., Pal, S. K., and Kailasam, K. (2018). Natural sunlight driven oxidative homocoupling of amines by a truxene-based conjugated microporous polymer. ACS Catal. 8, 6751-6759.
63. Wang, Z. J., Ghasimi, S., Landfester, K., and Zhang, K. A. I. (2015). Molecular structural design of conjugated microporous poly(benzooxadiazole) networks for enhanced photocatalytic activity with visible light. Adv. Mater. 27, 6265-6270
64. Mondloch, J. E., Katz, M. J., Isley Iii, W. C., Ghosh, P., Liao, P., Bury, W., Wagner, G. W., Hall, M. G., DeCoste, J. B., Peterson, G. W., Snurr, R. Q., Cramer, C. J., Hupp, J. T., and Farha, O. K. (2015). Destruction of chemical warfare agents using metal-organic frameworks. Nat. Mater. 14, 512-516.

What is claimed:

1. An organic framework comprising a plurality of structural units comprising a structure of formula I 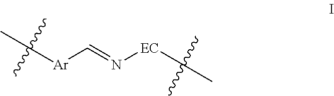
wherein Ar is a fused aromatic group, and EC is an electron-deficient chromophore.

2. The organic framework of claim 1, wherein the fused aromatic group comprises 2 to 10 fused aromatic groups.

3. The organic framework of claim 1, wherein the fused aromatic group comprises naphthalene, anthracene, acenaphthene, acenaphthylene, fluorene, phenalene, phenanthrene, benzo[a]anthracene, benzo[a]fluorine, benzo[c]phenanthrene, chrysene, fluoranthene, tetracene, anthanthrene, benzopyrene, pyrene, benzo[a]pyrene, benzo[e]pyrene, benzo[b]fluoranthene, benzo[j]fluoranthene, benzo[k]fluoranthene, corannulene, coronene, dicoronylene, diindenoperylene, helicene, heptacene, hexacene, kekulene, ovalene, pentacene, perylene, picene, or tetraphenylenepentacene.

4. The organic framework of claim 1, wherein the fused aromatic group comprises a pyrene.

5. The organic framework of claim 1, wherein the fused aromatic group is substituted with 2 to 8 aryl groups.

6. The organic framework of claim 1, wherein the fused aromatic group comprises a structure of formula II

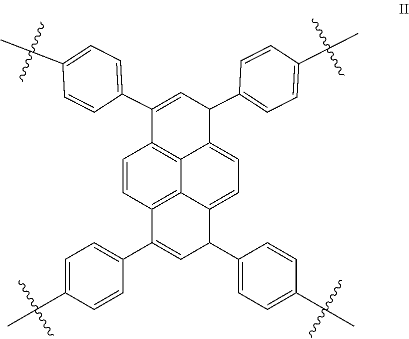 [SMILES: *c1ccc(C2=CC(c3ccc(*)cc3)c3ccc4c5c(ccc2c35)C(c2ccc(*)cc2)=CC4c2ccc(*)cc2)cc1]

7. The organic framework of claim 1, wherein the electron-deficient chromophore comprises a thiadiazole, a triazine, a heptazine, or an oxadiazole.

8. The organic framework of claim 1, wherein the electron-deficient chromophore comprises a structure of formula III 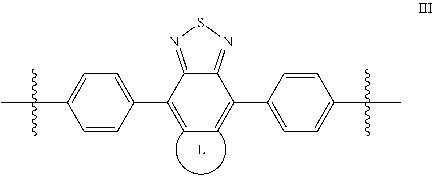
wherein L is not present or L is a fused aromatic group comprising 1 to 10 aromatic groups.

9. The organic framework of claim 1, wherein a structural unit comprises a structure of formula IV 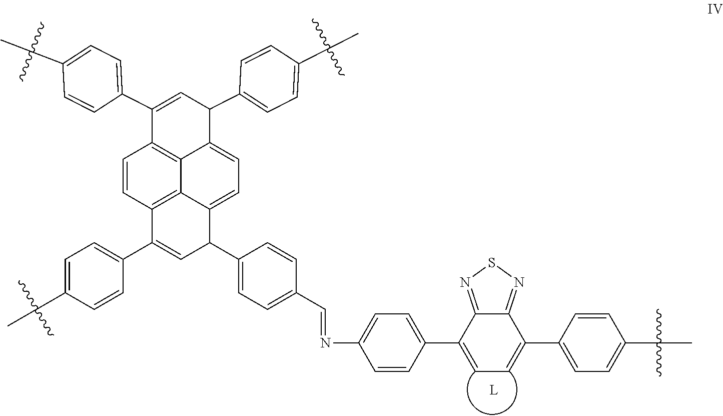
wherein L is not present or L is a fused aromatic group comprising 1 to 10 aromatic groups.

10. The organic framework of claim 9, wherein L is not present.

11. The organic framework of claim 1, wherein the framework comprises a plurality of structural units having the structure depicted in FIG. 1A.

12. An organic framework produced by reacting a fused aromatic group substituted with three or more amino groups with an electron-deficient chromophore comprising two aldehyde groups.

13. The organic framework of claim 12, wherein the fused aromatic group is 1,3,6,8-tetrakis(4-aminophenyl)pyrene.

14. The organic framework of claim 12, wherein the electron-deficient chromophore comprising two aldehyde groups comprises a structure of formula V 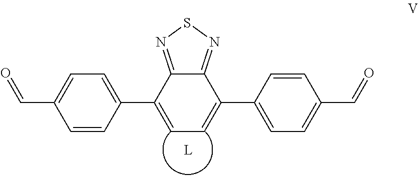
wherein L is not present or L is a fused aromatic group comprising 1 to 10 aromatic groups.

15. An organic framework produced by reacting a fused aromatic group substituted with three or more aldehyde groups with an electron-deficient chromophore comprising two amino groups.

16. The organic framework of claim 15, wherein the fused aromatic group is 4,4′,4″,4′″-(pyrene-1,3,6,8-tetrayl)tetrabenzaldehyde.

17. The organic framework of claim 15, wherein the electron-deficient chromophore comprising two amino groups comprises a structure of formula VI 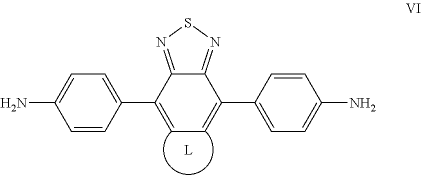
wherein L is not present or L is a fused aromatic group comprising 1 to 10 aromatic groups.

18. A method for oxidizing an organic compound, comprising:
exposing an organic compound to oxygen in the presence of the organic framework according to claim 1, and
irradiating the organic framework.

19. The method of claim 18, wherein the organic compound is a diene or sulfide.

20. A fiber comprising a coating of the organic framework according to claim 1.
